(19) United States
(12) Patent Application Publication
(10) Pub. No.: US 2008/0008188 A1
(43) Pub. Date: Jan. 10, 2008

(54) SYSTEMS AND METHODS FOR WIRELESS RESOURCE MANAGEMENT WITH QUALITY OF SERVICE (QOS) MANAGEMENT

(75) Inventors: Wladyslaw Jan Buga, Rancho Santa Fe, CA (US); Tracy Raymond Trent, San Diego, CA (US)

Correspondence Address: COOLEY GODWARD KRONISH LLP;ATTN: Patent Group, Suite 1100, 777 - 6th Street, NW, Washington, DC, 20001, US

(73) Assignee: PROXIMETRY, INC., San Diego, CA (US)

(21) Appl. No.: 11/754,093

(22) Filed: May 25, 2007

Related U.S. Application Data
(60) Provisional application No. 60/808,693, filed on May 25, 2006.

(51) Int. Cl. H04L 12/56

(52) U.S. Cl. 370/395.21

(57) ABSTRACT

Systems and methods for management of resources in wireless networks such as IEEE 802.11 and 802.16 networks are described. Wireless resource management within a network specific configuration may be implemented in a combination of hardware and software based on knowledge of network and device specific parameters. Management of resources may include management of quality of service (QOS) and management of wireless devices operating in accordance with multiple protocols within a dynamic and adaptive resource management architecture.

### CROSS-REFERENCE TO RELATED APPLICATIONS

This application claims priority under 35 U.S.C. § 119(e) of co-pending U.S. Provisional Patent Application Ser. No. 60/808693, entitled Wireless Resource Management, filed on May 25, 2006, which is incorporated by reference herein in its entirety for all purposes.

### BRIEF DESCRIPTION OF THE INVENTION

This invention relates generally to the field of wireless networks. More particularly, this invention relates to system and methods for resource management in wireless networks such as 802.11 and 802.16 networks, including dynamic resource management of processes, hardware, and software.

### BACKGROUND OF THE INVENTION

Traditional telecom (fixed wire) networks, such as the public switched telephone network (PSTN), have been developed with a static infrastructure configuration. Most or all network element locations, including end user telephone sets, modems, or other devices, are known and fixed. In addition, the capacity of the network is planned ahead of time.

In mobile cellular networks the network infrastructure and backbone elements are also typically static; however, end user devices such as mobile handsets can move throughout the network, and can be connected to the network dynamically and at different locations. As originally designed, cellular networks were configured as narrowband networks tailored for supporting voice communications. Many of these networks are now being upgraded using technologies such as code division multiple access (CDMA 1×RTT or 1×EDVO), or global system for mobile communications (GSM/UMTS) to add broadband capability.

Both of these types of cellular networks were designed to be fully manageable on an end-to-end basis and allow access only to their subscribers. In contrast, many wireless local area networks (WLANs) such as those based on the IEEE 802.11 standard for wireless local area networks (also known and denoted herein as Wi-Fi) and IEEE 802.16 standards for wireless metropolitan networks (WMANs), are designed to be broadband networks with shared media. Use of WLANs and WMANs has been growing rapidly, and these networks have begun to overlap on the territory and functionality of traditional telecom wired and wireless networks.

Enterprises, government, and telecom operators face key challenges as they begin adopting wireless networks, particularly for mission-critical applications. Popularity of wireless networks in residences is also growing for home computer networks, video and other media delivery, gaming, and other home networking purposes. These mobility solutions have significant differences from traditional wired data networks and present new problems related to configuration, provisioning, and management. In particular, failure to adequately manage network resources and operation in real time can lead to high latency, packet loss, and network congestion, resulting in decreased network performance. In some cases, failure to manage network resources may lead to performance degradation sufficient to render the network partially or completely ineffective.

Static network configurations and management controls typically work well for static device environments. With a static network environment network elements and operation can be configured based on known element locations and other known or predictable parameters to ensure at least a minimal level of service. However, wireless network characteristics and performance often fluctuate over time. Within any given day as well as week-to-week and month-to-month network performance may change due to a changing device environment as well as changes in real-time traffic requirements for content such as voice and video.

Wireless network standards such as IEEE 802.11 typically provide for a wide range of device configuration parameters, settings, and the like; however, equipment manufacturers typically set configurable parameters to default values and/or fail to configure or enable all of the network management capabilities in individual devices. Since network devices are available from a wide range of manufacturers, system level configuration and control of device parameters in order to manage network operation and optimize performance based on a particular network's requirements has been lacking. This type of overall network management and configuration control has not been addressed by individual equipment manufacturers who are normally unable to predict the particular network configurations or application requirements that their devices will be required to operate under. As a consequence, network performance quality has generally not been optimized based on the specific demands of a particular wireless network.

Dynamic and Adaptive Wireless Network Management

Based on past and current trends, the density of wireless devices will likely increase in an uncontrolled manner, and ad-hoc multi-hop communication will be introduced in the enterprise environment, thus increasing the risks of un-controlled interference and degradation of quality of service (QOS). At the same time, current technology lacks consistent configuration and coordination throughout an entire WLAN or WMAN, including access points and repeaters/distributed antennas. This configuration and coordination need includes both static/initial configuration (addressing, hardware settings, etc.) and dynamic configuration and provisioning (settings for QOS, security, and the like) performed for individual devices as well as for the network as a whole. Often all devices must be dynamically updated at the same time to ensure consistency.

The shared nature of the WLAN medium creates needs for continuous monitoring and control/modification to maximize performance and to minimize the interference. However, wireless network configurations and topologies may not be known a priori, as in the case of ad-hoc networks, or may be changing as mobile nodes are moving, appearing, and disappearing from the network. The current art does not, however, provide for dynamic, adaptive, real-time resource management to ensure guaranteed QOS for dynamic network configurations.

Quality of Service (QOS) Management

In a related aspect of wireless resource management, quality of service (QOS) management may be considered. There are many approaches to QOS management of packet-based transmission systems known in the current art. A typical QOS management process for packet based transmission systems will include packet classification, marking, queuing, and scheduling. These processes are static and not very granular. Marking of the packets is performed according to a classification rule, and typically is limited to a relative priority between packets to be transmitted. These packets are then placed into queues according to their relative priorities. A scheduling function is responsible for determining which packet should be sent next on the transmission medium. A number of scheduling algorithms currently exist for both wireline and wireless transmissions.

A typical scheduling algorithm for wireline transmission involves allocating constant and known link capacity/bandwidth between traffic flows (packets) according to a predefined and static rule. Examples include first in, first out (FIFO), weighted fair queuing (WFQ), and well as others. Scheduling in wireless networks requires different approaches as the capacity/bandwidth of the link varies in time, depends on location, and is subject to other environmental conditions. In addition, most of the existing scheduling algorithms assume some type of channel conditions, without a real knowledge of the channel's true conditions, thus potentially making these algorithms ineffective, and sometimes even counterproductive.

Typically these algorithms are “hardwired” into the wireless device, such as the base station or access point. In wireless networks, network configurations and topologies may not be know a priori, as in the case of ad hoc networks, or may be changing as mobile nodes are moving, appearing, and disappearing from the network. In certain cases such algorithms fail to provide desired levels of QOS in the face of changing network conditions.

Multi-Protocol Management

In another aspect of wireless resource management, management of multi-vendor devices using multiple types of management and control interfaces, also denoted herein as multi-protocol management, may be considered.

Network management may be defined as the execution of the set of functions required for controlling, planning, allocating, deploying, coordinating, and monitoring the resources of a network. This may include performing functions such as initial network planning, frequency allocation, predetermined traffic routing to support load balancing, cryptographic key distribution authorization, configuration management, fault management, security management, performance management, accounting management, as well as other aspects of network management.

A large number of protocols exist to support network and network device management. Common protocols include SNMP, CMIP, WBEM, Common Information Model, Transaction Language 1, Java Management Extensions, netconf, and other protocols and standards. Despite these standards, management and control of networks comprising multi-vendor device that use multiple types of management and control interfaces is a difficult task.

Typically, network management functions are executed via communications between a management agent and a manager carried over a management interface. A management agent is a software agent that runs on a managed device and provides an interface to management resources. It can perform operations on managed objects or resources in the device on its own or on request from a manager. It can also forward notifications to the manager. As used herein, a management manager is a software program that runs on a management server and manages communications with management agents.

A typical management and control interface is composed of two parts: an information part and a communications part. The information part is concerned with what information is passed through the interface and is defined by messages carrying data between respective systems. This information describes the resources to be managed and controlled. The communications part is concerned with what communications protocols (capabilities) are used and is defined by its communications protocol profile (communications facilities). The need for multi-vendor environments and interoperability is driving standardization of management and control interfaces. This standardization includes both the information and communications parts.

For standard interfaces, information is an abstraction of the resources to be managed and controlled, presented in a machine/computer readable and standardized format. The communications part is a set of operations (such as get, set, filter, etc.) to be performed on the information, presented as a set of standard management messages and frames. Frequently for new technologies and high performance systems, proprietary management and control protocols are initially used. Later, these proprietary solutions may be used as a base for standardization by a standard organization such as IEEE, ITU, or IETF.

In the realm of WLAN standards, abstractions of resources are still not available for 802.11 mobile terminals, and an abstraction of the 802.11 MAC layer, addressing which link-layer protocols must use, is still evolving to a standard definition. Thus, for management and control of 802.11 mobile terminals and MAC resources proprietary interfaces have to be used, and these differ for each radio type and are often tightly coupled to dedicated hardware.

To overcome this lack of standard interfaces, most devices have a built in command line interface (CLI) for configuration and troubleshooting purposes. Network access to the CLI has traditionally been through the TELNET protocol, while the SSH protocol is becoming more popular to address security issues associated with TELNET. It is important to note that typical command line interfaces are proprietary, and they cannot be used efficiently to automate processes in an environment with a heterogeneous set of devices.

### SUMMARY OF THE INVENTION

The present invention is generally related to systems and methods for wireless resource management. More particularly but not exclusively, the present invention relates to the dynamic management of wireless networks and associated network resources such as IEEE 802.11 WLANS and 802.16 WMANs.

In one aspect the present invention is related to a software architecture and functions that enable management of wireless networks and their resources according to rules, policies, quality of service (QOS) requirements, context, and other requirements driven by users, applications, and conditions. Such wireless networks may be deployed at various enterprises (such as hospitals, factories, retail operations, transportation, and small and large businesses), telecom service operations (such as wireless ISPs, municipal wireless networks), government agencies (such as public safety, homeland security, and defense/military), in homes, apartments, and other residences, as well as in other locations where similar networking functionality is required.

In another aspect, the present invention relates to hardware and hardware/software devices and configurations for implementing and managing a wireless network based on one or more network specific criteria. Such criteria may include throughput, specific types of network content such as text, voice, video, audio or other content, quality of service, or other network customization parameters and requirements such as are described herein.

In another aspect the present invention relates to systems and methods of provisioning and dynamic resource management (DARM) for managing enterprise resources in a wireless network.

In another aspect the present invention relates to systems and methods for provisioning and managing quality of service (QOS) in a wireless network.

In another aspect the present invention relates to systems and methods for provisioning and providing multi-protocol management in a wireless network comprised of devices operating in accordance with multiple protocols.

Additional aspects of the present invention are contemplated as described herein.

### BRIEF DESCRIPTION OF THE FIGURES

The invention is more fully appreciated in connection with the following detailed description taken in conjunction with the accompanying drawings, in which:

FIG. 1 illustrates a typical wireless network managed in accordance with aspects of the present invention.

FIG. 2 illustrates a high level object model of an embodiment of the present invention.

FIG. 3 illustrates an embodiment of a User/Account object model in accordance with aspects of the present invention.

FIG. 4 illustrates an embodiment of a Group object model in accordance with aspects of the present invention.

FIG. 5 illustrates an embodiment of a Service/Application object model in accordance with aspects of the present invention.

FIG. 6 illustrates an embodiment of Service Provisioning workflow in accordance with aspects of the present invention.

FIG. 7 illustrates an embodiment of a Device object model and relationships in accordance with aspects of the present invention.

FIG. 8 illustrates an embodiment of a Device Agent architecture in accordance with aspects of the present invention.

FIG. 9 illustrates an embodiment of an Enterprise Wireless Management (EWM) system in accordance with aspects of the present invention.

FIG. 10 illustrates an embodiment of a Functional Architecture according to aspects of the present invention.

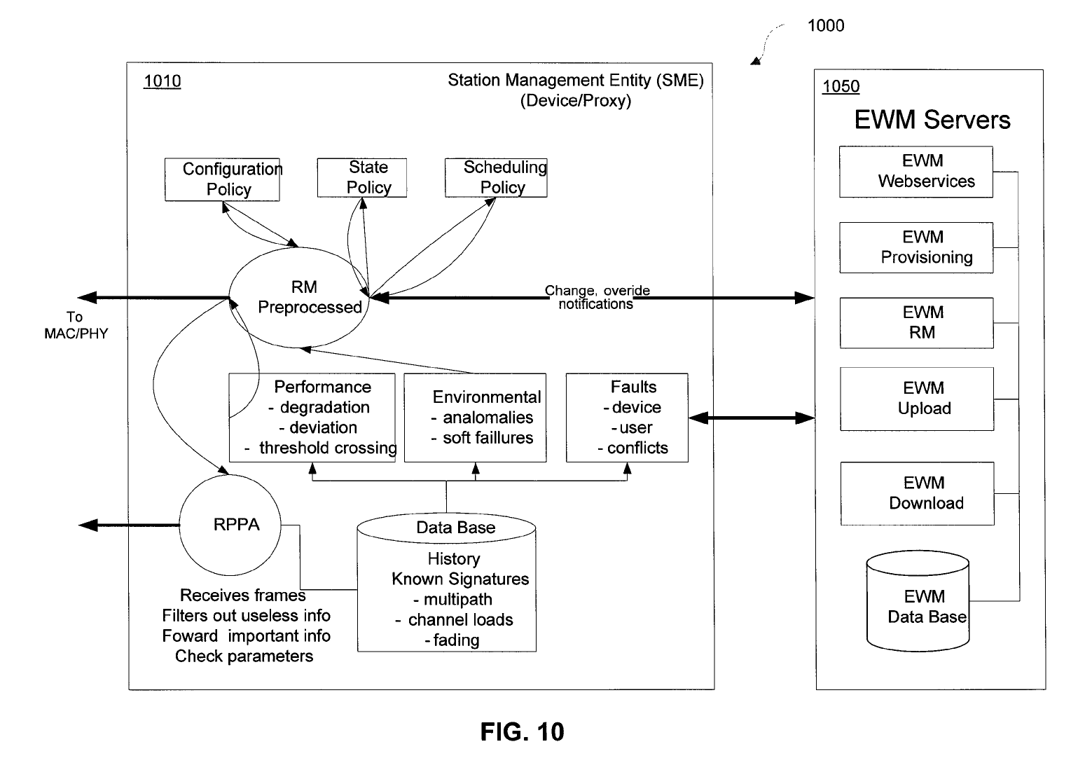

FIG. 11 illustrates an embodiment of an EWM functional binding process in accordance with aspects of the present invention.

FIG. 12 illustrates an embodiment of EWM sequential functions and associated processes.

FIG. 13 illustrates an embodiment of static relationships associated with FIG. 11.

FIG. 14 illustrates an embodiment of an administrative, configuration, and provisioning in accordance with aspects of the present invention.

FIG. 15 illustrates one embodiment of a DARM system configuration and management process using a station management entity (SME).

FIG. 16 illustrates one embodiment of a DARM system configuration and management process using an SME proxy appliance.

FIG. 17 illustrates one embodiment of a DARM system configuration and management process in the context of an 802.11 wireless network.

FIG. 18 illustrates one embodiment of quality of service (QOS) system configuration and management.

FIG. 19 illustrates an embodiment of a representative multi-protocol system architecture and management configuration.

FIG. 21 illustrates one embodiment of a multi-protocol architecture and module interconnectivity.

### DETAILED DESCRIPTION OF THE INVENTION

The present invention is related to network resource management in wireless networks. While embodiments of the present invention disclosed below are typically described in terms of wireless local area networks (WLANs) such as those based on the popular IEEE 802.11 wireless local area network standards (also known as WI-FI), the systems and methods described herein are not so limited, and embodiments based on other WLAN configurations, as well as wireless wide area networks such as 802.16 wireless networks (WMANs), are possible and fully contemplated herein. Accordingly, the embodiments disclosed are merely provided for purposes of illustration, not limitation.

The present invention is generally related to systems and methods for wireless resource management. In one aspect the present invention is related to a software architecture and functions that enable management of wireless networks and their resources according to rules, policies, quality of service (QOS) requirements, context, and other requirements driven by users, applications, and conditions. Such wireless networks may be deployed at various enterprises (such as hospitals, factories, retail operations, transportation, and small and large businesses), telecom service operations (such as wireless ISPs, municipal wireless networks), government agencies (such as public safety, homeland security, and defense/military), in homes, apartments, and other residences, as well as in other locations where similar networking functionality is required. Typical deployments may consist of either or both in-door and out-door installations in any of the above environments. It will be noted that, as used herein, the term “enterprise” may interchangeably be used to refer to any of the above settings as well as any equivalents.

In another aspect, the present invention relates to hardware and hardware/software devices and configurations for implementing and managing a wireless network based on one or more network specific criteria. Such criteria may include throughput, specific types of network content such as text, voice, video, audio or other content, quality of service, or other network customization parameters and requirements such as are described herein.

In another aspect the present invention relates to dynamic resource management systems and methods (DARM) for managing enterprise resources in a wireless network.

In another aspect the present invention relates to systems and methods for managing quality of service (QOS) in a wireless network.

In another aspect the present invention relates to systems and methods for providing multi-protocol management in a wireless network.

Additional aspects of the present invention are also contemplated as further described herein.

Certain embodiments of the present invention are premised on providing knowledge based applications for wireless networks. A knowledge based application is one that can be aware of its resources, contexts, and performance and tailor network performance accordingly. Such awareness may be in real or near real time, and may be adaptive to changing conditions, and adaptive to the requirements of transmitted applications. This awareness may include knowledge of one or more of the following: application semantics knowledge; flow, frame, and packet header knowledge; connection parameters/information knowledge; RF resources (such as transmit power, channel bandwidth, etc.); channel condition (such as noise, received signal strength. etc.); channel performance (operating margin, bit error rate (BER), etc.); loading and resource requirement issues in the network that can lead to performance degradation; as well as other related information.

It will be noted that certain aspects of the present invention are described below with reference to the open systems interconnection model. The open systems interconnection basic reference model (OSI model) is a layered abstract description widely used for communication and network protocol design. The OSI model consists of seven layers, wherein each layer includes one or more entities/modules implementing its functionality.

The OSI model layers include Layer 1 (Physical Layer); Layer 2 (Data Link Layer, Media Access Control); Layer 3 (Network Layer); Layer 4 (Transport Layer); Layer 5 (Session Layer); Layer 6 (Presentation Layer); and Layer 7 (Application Layer). Each entity normally interacts directly only with the layer immediately below it, and provides facilities for use by the layer above. Associated protocols may be used to enable an entity in one device to interact with a corresponding entity at the same layer in another device.

Within the OSI framework, wireless network resources are normally managed at Layer 2 (Data Link Layer, also denoted as DLC/MAC) and Layer 1 (Physical Layer, also denoted as PHY) of the OSI model, using their services and protocol messages (also denoted as protocol data units or PDUs). Wireless network resource management, may, however, benefit from additional knowledge or information outside the PHY and DLC/MAC layers.

For example, knowledge about application semantics, connection, flow, frame, and packets can be acquired from information available at higher layers (Layers 3 through 7) of the OSI model, providing additional information that can be used for resource management. Consequently, embodiments of enterprise wireless resource management according to aspects of the present invention can be implemented by taking a broad, holistic view that may include one or more of the following: Users and groups of users defined by their associated accounts and their client devices; Network and client devices used to run software applications and to communicate with other devices and networks; Software applications with their associated parameters, profiles, statuses and other attributes; An intelligent and adaptive network/transport layer; Services that are designed by associating the above components, including a number of conditions, rules and policies; as well as other network information and parameters.

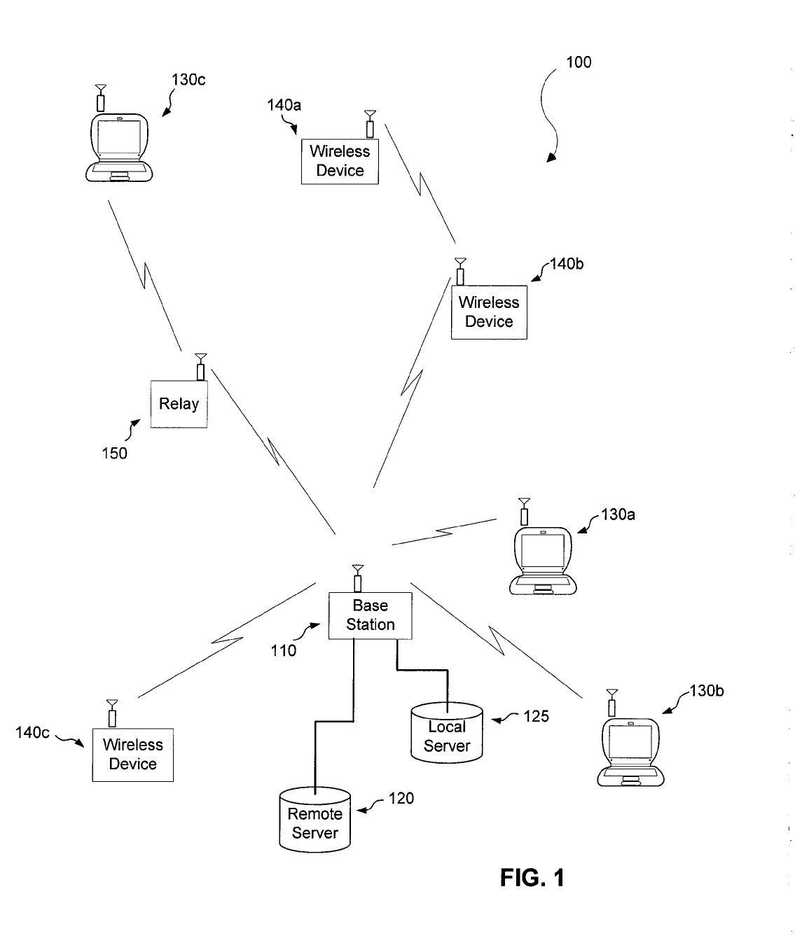

Turning now to FIG. 1, a typical enterprise wireless network 100 is illustrated wherein wireless resource management in accordance with aspects of the present invention may be implemented. As shown in FIG. 1, a wireless network may comprise one or more wireless base stations 110 such as access points, wireless hubs, routers, servers, or other devices providing control functionality over other network devices as well as providing connectivity to other networks such as the Internet. Base station 110 may include one or more modules implemented in hardware, software, or some combination of both to provide control and functionality to the network. In addition, control functionality may be distributed throughout additional network devices as described below. Base station 110 may include a local server and/or may be connected to a local server 125.

Base station 110 may be connected to a wired or wireless connection such as the Internet, telephony infrastructure, or other networks to provide a wide area network backbone. Base station 110 may also be connected to a remote server 120 through wired or wireless networks including the Internet, and may also be connected to other networks or networking backbones.

Base station 110 is configured to communicate with other wired and wireless devices within the network. For example, base station 110 may communicate with one or more wireless computer devices 130, such as rack mountable computers, desktop computers, portable computers, notebook computers, embedded computers, or other computer devices configured with wireless connectivity. Base station 110 may also be in wireless communication with other wireless devices 140 such as personal digital assistants (PDAs), other portable devices, or any other wireless enabled devices supporting the relevant wireless networking standards used by the network.

The managed wireless network may also include one or more node or repeater devices 150. Such devices may be used to extend the range of the network beyond the reach of a particular access point. For example, node 150 as shown in FIG. 1 may be configured and operative to extend the signal from access point 110 to a remote computer device 130c.

In some embodiments a managed network may comprise two or more wireless devices operating in an ad-hoc mode, such as is shown in FIG. 1 wherein wireless devices 140a and 140b may be configured and operative to communicate directly with each other.

While FIG. 1 is representative of a typical wireless network, it will be apparent that a wide variety of other network devices and configuration are possible and contemplated herein.

In accordance with exemplary embodiments of the invention, one or more elements of a managed wireless system may be described with respect to object models wherein the objects illustrate users of the system or components of the system. As described herein, objects may represent both users as well as components of a wireless management system such as may be implemented in hardware, software, or combinations of hardware and software. Some objects may consist of standalone modules or applications, whereas some objects may comprise multiple or distributed modules or applications.

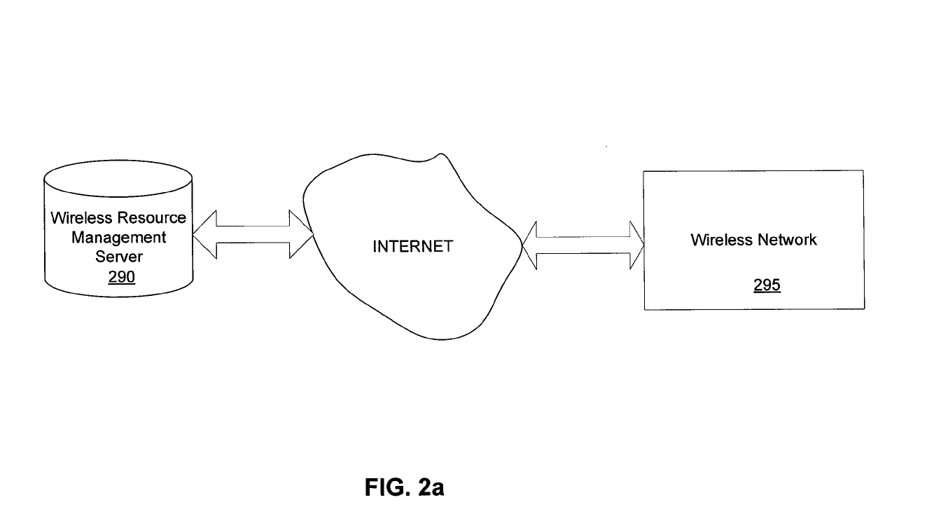

FIG. 2a illustrates a simplified high level view of a managed wireless network according to aspects of the present invention wherein such an object model may be employed to provide management wireless network functionality. As shown in FIG. 2a, one or more wireless resource management servers 290, such as servers 120 or 125 as shown in FIG. 1, may implement elements of a server side object model as described below. Server 290 may be connected either directly to the managed network 295 or may be connected through the Internet as shown in FIG. 2a.

Attention is now directed to FIG. 2b which illustrates a server side high level object model 200 of one embodiment of a managed enterprise according to aspects of the present invention. As illustrated in FIG. 2b, server side management may comprise management of one or more system objects including users (also denoted herein as accounts) 210, groups 220, devices 230, software packages 240, services 250, and roles 270. A user 210 may be based on a particular individual user, group of users, or other user configurations. A particular wireless resource management system may comprise one or more users 210, wherein each user may further comprise one or more user attributes. Information related to users may be provided to the resource management system to customize network management and operations based on specific network requirements. Group 220 associates users 210 with one or more devices 230, roles 270, and software packages 240. Each software package 240 may be associated with one or more package items 244. Each group 220 may have one role 270 assigned. Assignment between roles and groups defines which services 250 will be accessible on devices 230 assigned to the specified group 220. Services 250 may contain preset service parameters 252, which define service 250 properties. Service parameters 252 may have predefined values such as: UpStreamBandwidth, DownStreamBandwidth, service priority, maximum delay, and the like. Group structure may be hierarchical. A group may have an assigned priority 211. Priority of a group may be inherited from a superior group.

For example, service 250 may represent a network or communications service, realized as a service flow with its associated QOS profiles. Each service 250 must be one of a service class 251. Each service can have multiple parameters assigned (however, in an exemplary embodiment each parameter can be assigned only once). The relation to a service class defined how a service instance or flow is identified in the network. A role 270 represents a group of services 250 and rules 271 under which these services are used and managed.

A managed enterprise will comprise one or more devices 230 such as those devices shown in FIG. 1. Devices may include any of a wide variety of network devices such as, for example, 802.11 routers, hosts, portable devices, wireless computers, repeaters, or other networking enabled devices. Information related to various characteristics of each device may be provided to the resource management system to customize operation based on specific network requirements. Each device may further have specific attributes such as device types 234 and statistics 231. Within each device type there may further be defined or configured one or more communication channels and channel information 236 as well as device profile information 238. Device type 234 attributes may include information such as manufacturer's name, model number, or other similar information. Statistics 231 may include information such as device communication parameters, services used, logs, performance parameters, or other related statistical and data information. Communication channel 236 may include information such as the name of a specific communication, management or control protocol available to the device type. Device type 234 profiles may further describe characteristics such as maximum bandwidth, maximum storage, maximum loading, and other characteristics of the device.

It will be noted that in various embodiments an Enterprise Wireless Manager (EWM) server side system may be used to manage the objects as shown in FIG. 2b as well as their relationships with other objects. In addition, other object classes, such as tickets, reports, billing, and the like may be used to support management of the enterprise.

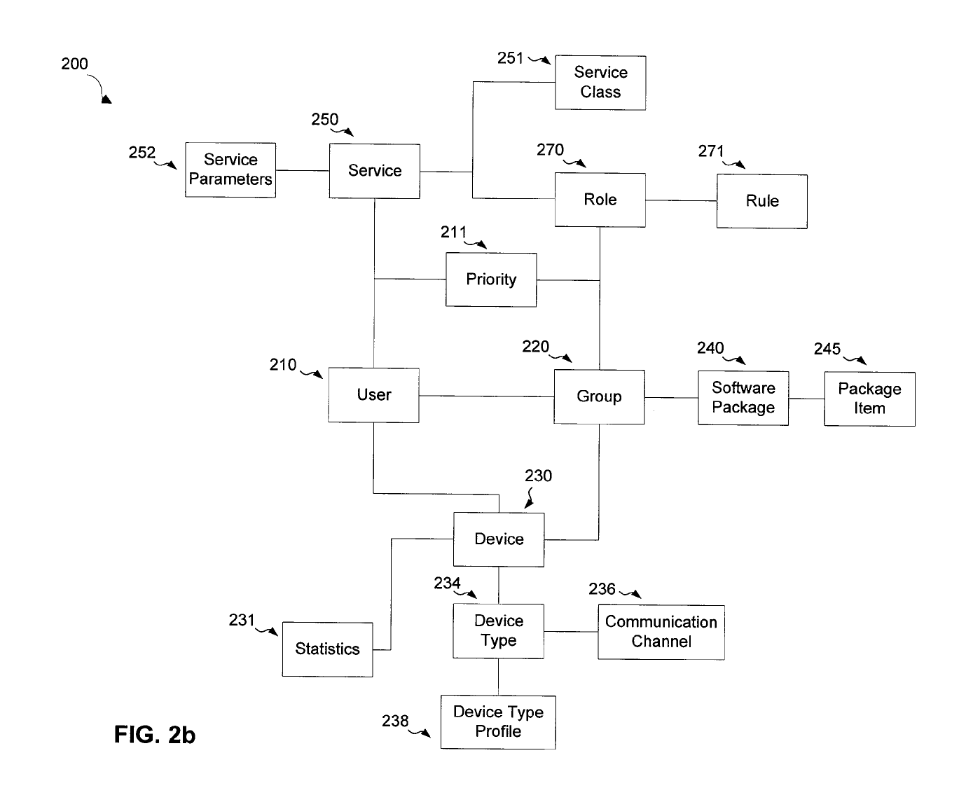

Attention is now directed to FIG. 3, which illustrates one embodiment of an user object model 300 showing a user object 310 along with typical relationships with other objects. A user 310 is an object used to associate users or groups of users with other objects such as services, applications, tickets, and the like. The user object represents a user of the enterprise wireless management system, which is also an owner of the end-user device. User attribute 312 represents any attributes of the user. Role 370 represent's the user's role in the network, which may be both a bundle of services a user can be provisioned with as well as rules under which those services are available.

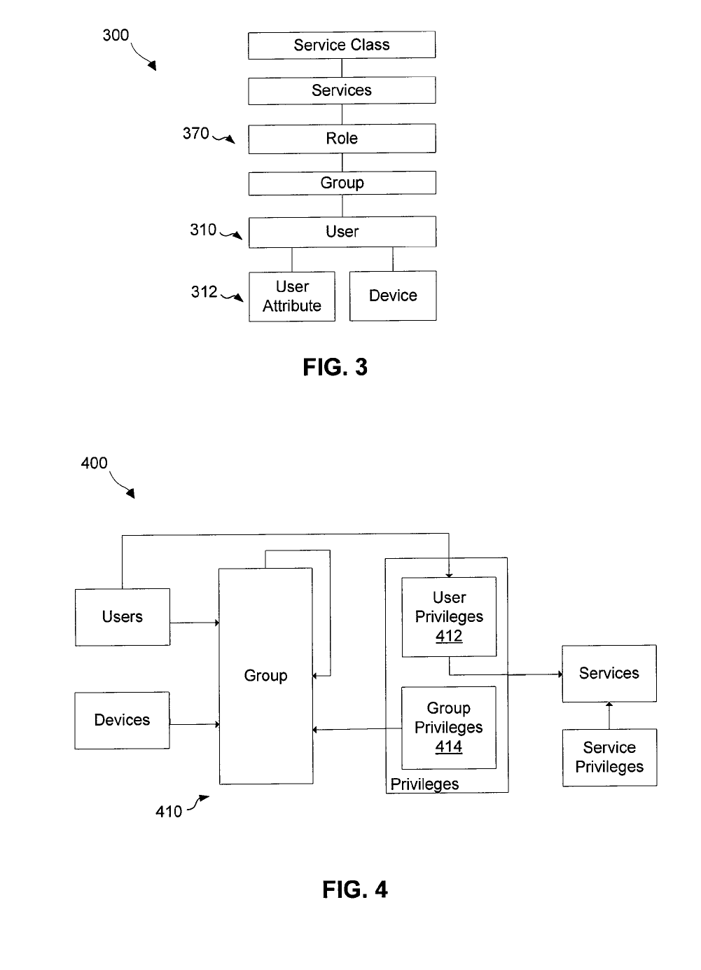

Attention is now directed to FIG. 4 which illustrates one embodiment of a group object model 400. Group 410 may be associated with users, devices, roles, priorities, and other objects and attributes, such as software packages, as show in the FIG. 4. A group object represents a group of users and devices, used for associated provisioning. User privileges 412 and group privileges 414 may be used to define privileges for an administrator to manage an EWM system.

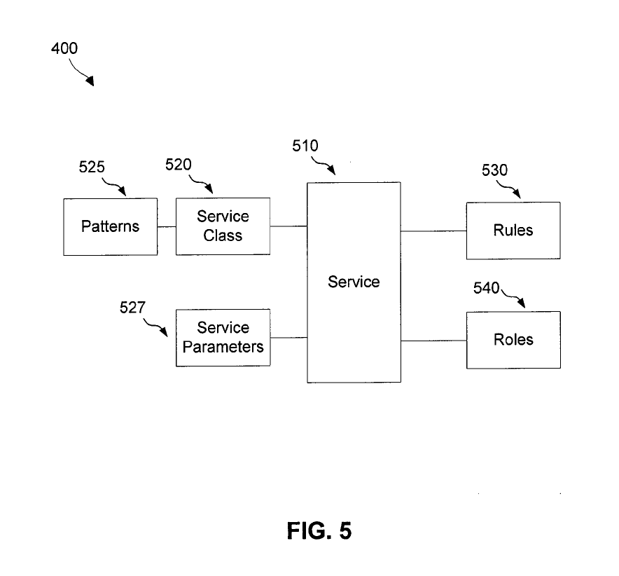

Attention is now directed to FIG. 5 which illustrates one embodiment of a service object model 500. Service class object 520 represents a generic service class that may be used to define a set of methods used to classify service flows of this class. Pattern object 425 represents a method of classification. Service parameters object 527 may be used to describe parameters of the service, for example bandwidth, priority, and the like. Service object 510 defines a service in the system, which represents a basic provisioning unit. Rule object 530 defines a dynamic behavior of the system per service, e.g., invoking a service degradation or other adaptation action or method to optimize behavior and performance in case of some network event. Groups, users, devices and service objects may be defined by their association to patterns, parameters, rules, roles, and the like as shown in the FIG. 5.

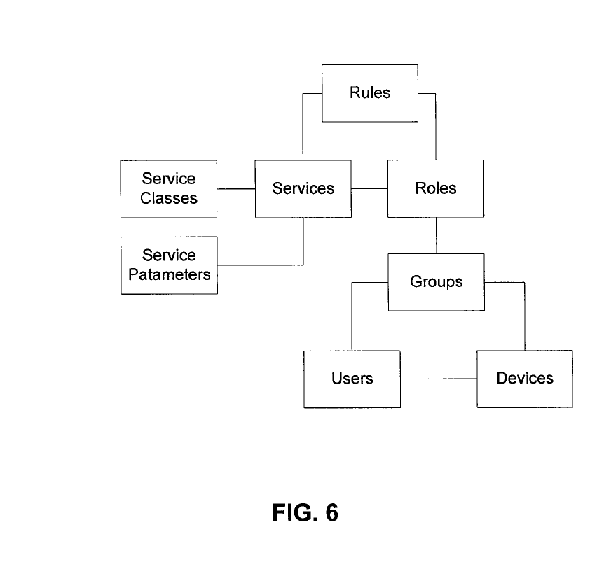

Attention is now directed to FIG. 6 which illustrates one embodiment of an example of service provisioning in accordance with aspects of the present invention. Service design and provisioning is a process of defining relationships between objects such as those shown in FIG. 6 and assigning various parameters, roles, and rules to groups and services to enable dynamic, adaptive, and closed loop management of wireless systems.

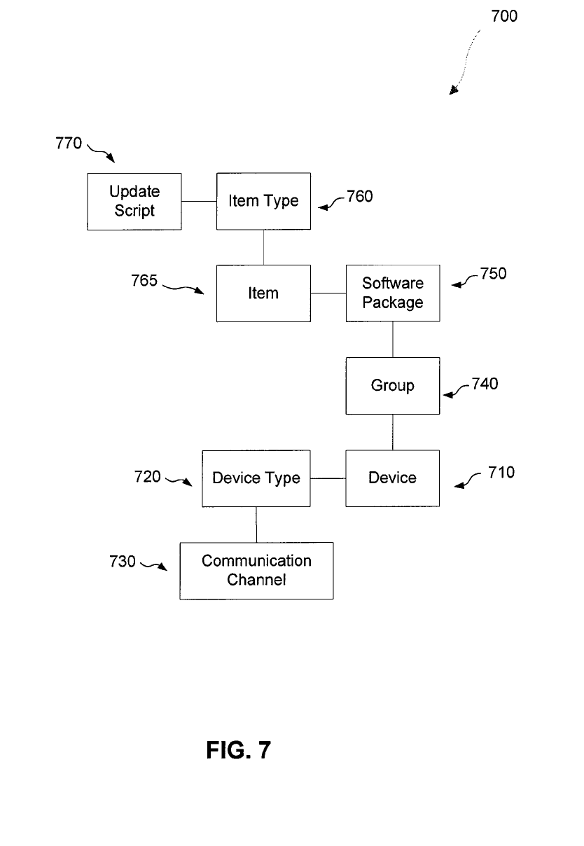

Attention is now directed to FIG. 7, which illustrates one embodiment of a device object model 700 and associated relationships. Device objects 710 may be used to represent devices such as PDAs, tablets, laptops, mobile phones, cameras, other handheld wireless devices, access points and other devices and device types used by the enterprise. Devices can be grouped by device types, and can be characterized by their communications capabilities and other parameters, profiles, and rules. A device can be associated with users or group of users, and with various software packages containing network properties and other items. Devices may interact with other devices or objects such as is shown in FIG. 7. Device type object 720 represents the type of device and shared device properties. Communication channel object 730 defines the communications protocols and services that can be used by the device to communicate with other systems and devices. Communications can be used for data exchanges, real time and multimedia communications, as well as control and management functions. Examples of protocols that may be used in exemplary embodiments are CAPWAP, SNMP, TCP, IP, UDP, SIP, SOAP, 802.11, 802.16 and the like. Software package object 750 groups a set of software components such as device configuration files, programs, device images, and other content that may be downloaded as a bundle or as individual components to a device for management and control purposes and/or for other user needs, applications, or uses. Item object 765 is a software component that can be shared between different software packages. Item type object 760 represents a type of software item distinguished by its properties, usage, interfaces, behavior and other attributes including a description of a method for its installation and configuration. Update script object 770 defines a set of commands for installation, configuration, and other behavior and performance of the item.

The objects illustrated in a representative fashion in FIGS. 2-7 are typically implemented on the server side of the managed wireless network, and are typically managed and administered by enterprise personnel such as system administrators. In typical embodiments, however, there is also a device (client) side of the managed wireless network that is provided to manage wireless devices and their relationships, such as is shown in FIG. 7. More specifically, in some embodiments a software client (device agent) may be used for deployment on the device. Further, in some embodiments multiple agents (software clients/modules) may be present on a device. As used herein, the term “device agent” may be used to describe any or all of them.

A device agent may be used and given the responsibility for managing device resources, for communications with management servers (EWM servers) via external networks, for communications with device resources via device internal communications mechanisms such as APIs, and for other related or similar purposes.

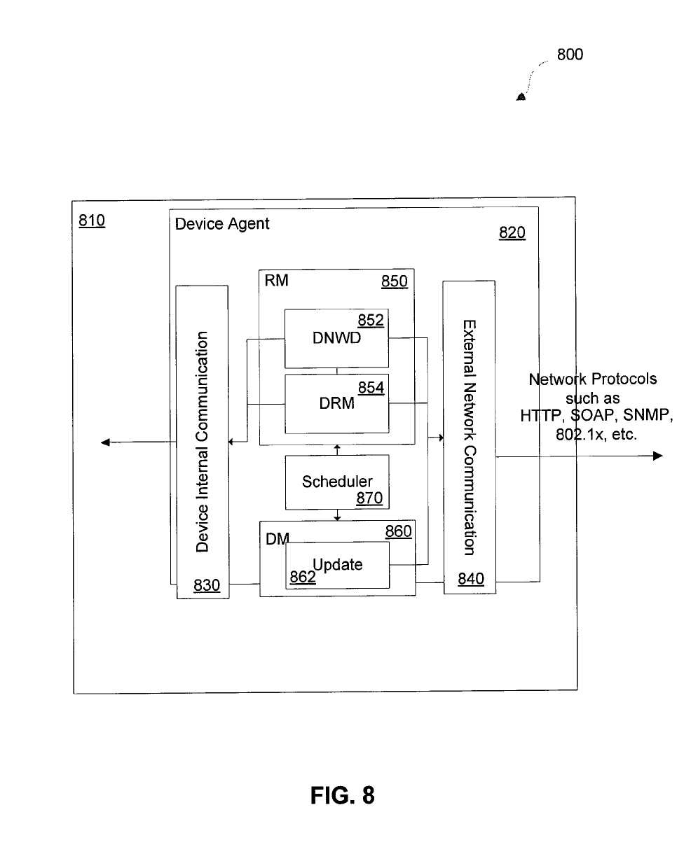

One embodiment of a device agent architecture is illustrated in FIG. 8. As shown in FIG. 8, a device 810 may include one or more device agents 820, in the form of software, hardware, or software/hardware modules. A device agent may include an internal resource manager (RM) 850, scheduler 870, device manager (DM) 860, device internal communications module or modules 830, external communications network module 840, and other components associated with device functionality as described elsewhere herein. Device internal communication module 830 is a layer for communication with the device, for example for reading, writing, and changing management information base (MIB) values using standard and proprietary service access points (SAPs). Distributed network detector module (DNWD) 852 is used for detecting, observing, analyzing, correlating, and tracking network changes and events. Distributed resource manager (DRM) module 854 is used for managing and controlling the network node. Scheduler object 870 is used to invoke and manage periodic and other time related operations of the agent. Update object 862 is a module for updating content, configuration, and other software components present on the device. External network communication module 840 is a layer for communication with external systems and applications, and it defines the communications protocols and services that can be used by the device for such communications. These communications can be used for data exchanges, real time and multimedia communications, as well as for control and management functions. Examples of such protocols include CAPWAP, SNMP, TCP, IP, UDP, SIP, SOAP, 802.11, 802.16, and the like.

In some embodiments, a Device Manager (DM) module or subsystem 860 may be provided to assist the EWM in management and control of devices and their associated relationships such as is described representatively in FIG. 7. The DM may be configured and operative to communicate with EWM servers to perform one or more of the following functions, as well as others: Device image rehashing; Software package updates (full and incremental); Device reconfiguration; Device monitoring; Device security; and other functions.

In some embodiments, the DM module may be used to serve as a component for implementation of a dynamic adaptation system and process configured and operative to manage dynamic device and network configurations according to rules, policies, triggers, and other attributes and conditions.

In some embodiments, a device agent may be a part of a dynamic and adaptive resource manager (DARM) system configured and operative to manage and control wireless network resources dynamically and adaptively. DARM real time management functions may include one or more of the following as well as others: performance optimizations; interference avoidance; quality of service (QOS) management; and other specialized applications and techniques. Additional details of embodiments of a DARM system are provided below and in subsequent sections.

In an exemplary embodiment a DARM system may include management servers and a number of other management and control agents in addition to a device agent. As noted elsewhere herein, agents are software clients/modules deployed on a wireless devices, and multiple agents may be present on a device. Each agent may be assigned responsibility for a specialized management and/or control function, such as device management, radio resource management, application performance optimization, etc.

As will be described below, in exemplary embodiments, all EWM components and servers such as DM, RM, and device agents are configured and operative to work together to enable conditional provisioning and dynamic management of the enterprise wireless network and mission critical applications using the wireless network and its resources.

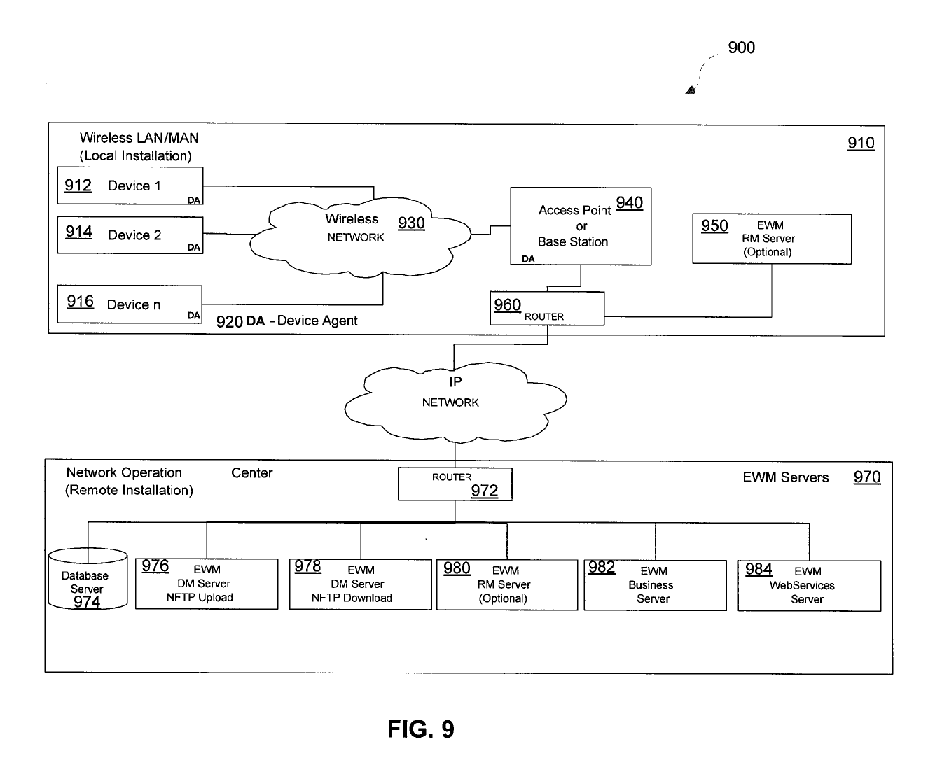

Attention is now directed to FIG. 9 which illustrates a typical EWM deployment scenario and system 900. As shown in FIG. 9, a wireless LAN/MAN 910 may include one or more wireless devices 912, 914, 916. It will be noted that the number of wireless devices is not limited in any way as shown in FIG. 9. Any or all of the devices may include a device agent module 920 configured to manage one or more elements of device operation. Exemplary device agent embodiments are described in further detail elsewhere herein. Each device may connect through a local wireless LAN/MAN 930 to a base station 940, access point, or equivalent device, which may then be connected to or integrated with a router 960. The LAN/MAN 910 may also include an optional RM server 950 to provide management functions as described elsewhere herein, as well as other devices that may be connected to the particular wireless network.

The LAN/MAN 910 may also be connected to a remote installation 970 such as a network operation center (NOC) or similar facility housing one or more EWM servers. The remote facility may include a router 972, database server 974, EWM DM Server NFTP Upload 976, EWM DM Server NFTP Download 978, optional RM Server 980, EWM Business Server 982, EWM WebServices Server 984, as well as other servers or devices. Additional details of embodiments of these servers and their associated functionality is describe elsewhere herein.

As used herein, a service is an assembly of components that have to be identified and placed appropriately in a network and associated devices. Service provisioning is the task that operates on a service already that has already been designed in order to provide a runtime instance of the service. One example of an embodiment of service provisioning is shown in FIG. 6.

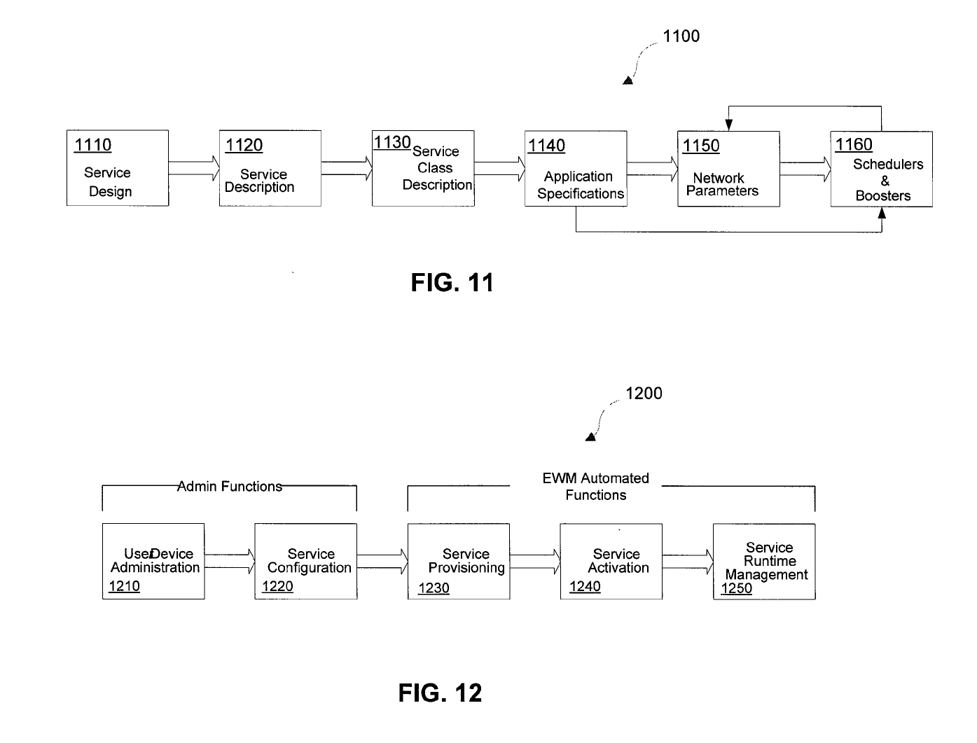

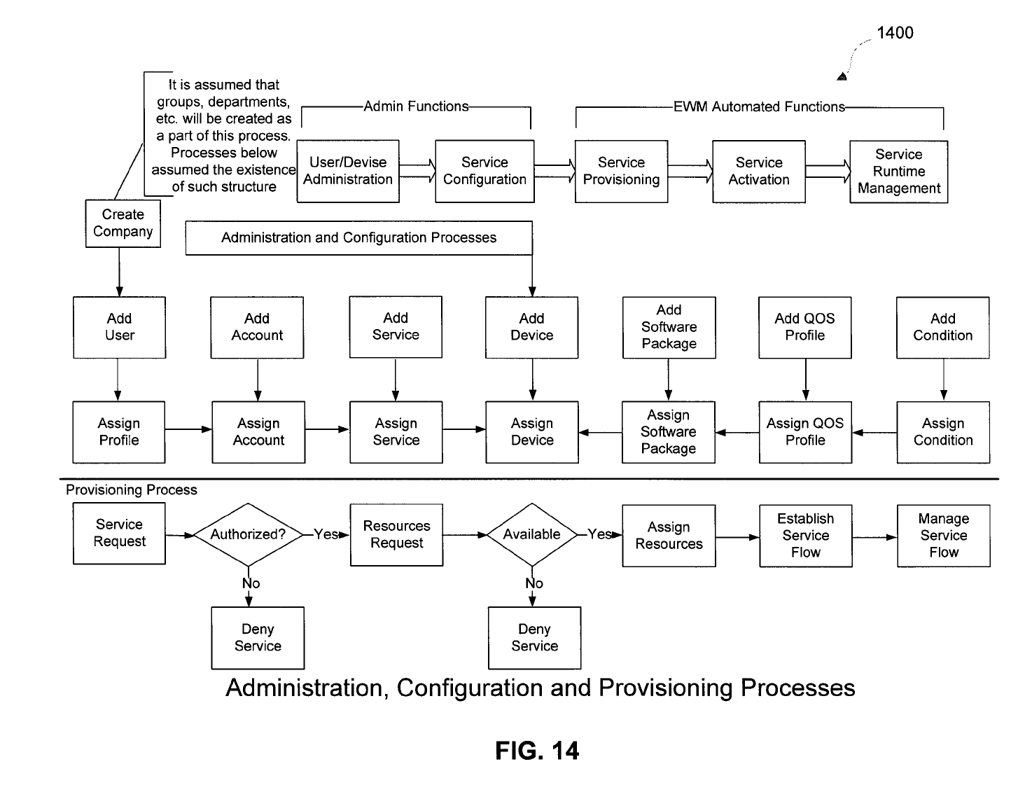

EWM's managed object classes, such as user, group device, application, profile, and attributes may be used as components for the design and configuration of a specific service, based upon context, profiles, performance metrics, or other needs. FIG. 11 illustrates one embodiment of a workflow of service design steps and the required EWM functional binding process. As shown in FIG. 11, the process starts with a basic design at step 1110. Additional details of the service may be provided at step 1120, such as, for example, temporal parameters. For example, a temporal parameter may include a period that enterprise is managed, such as 24 hours/day for a factory. At step 1130 a service class description is provided, this may include a description of the service to be provided, such as, for example, realtime voice over IP. It will be noted that all the steps prior to step 1140 typically done before the specific network use case is determined. In successive steps starting with step 1140 dynamic/configurable parameters may be provided/processed based on application specifications. For example, an application may be directed to voice, video, data, or other parameters. These may be defined/provisioned at step 1140. In step 1150 network parameters such as network devices, characteristics, and the like may be provided. Finally, schedulers and boosters may be provided such as scheduling packets in devices, real time provisioning, and the like. FIG. 13 illustrates a more detailed embodiment of this process showing these static relationships.

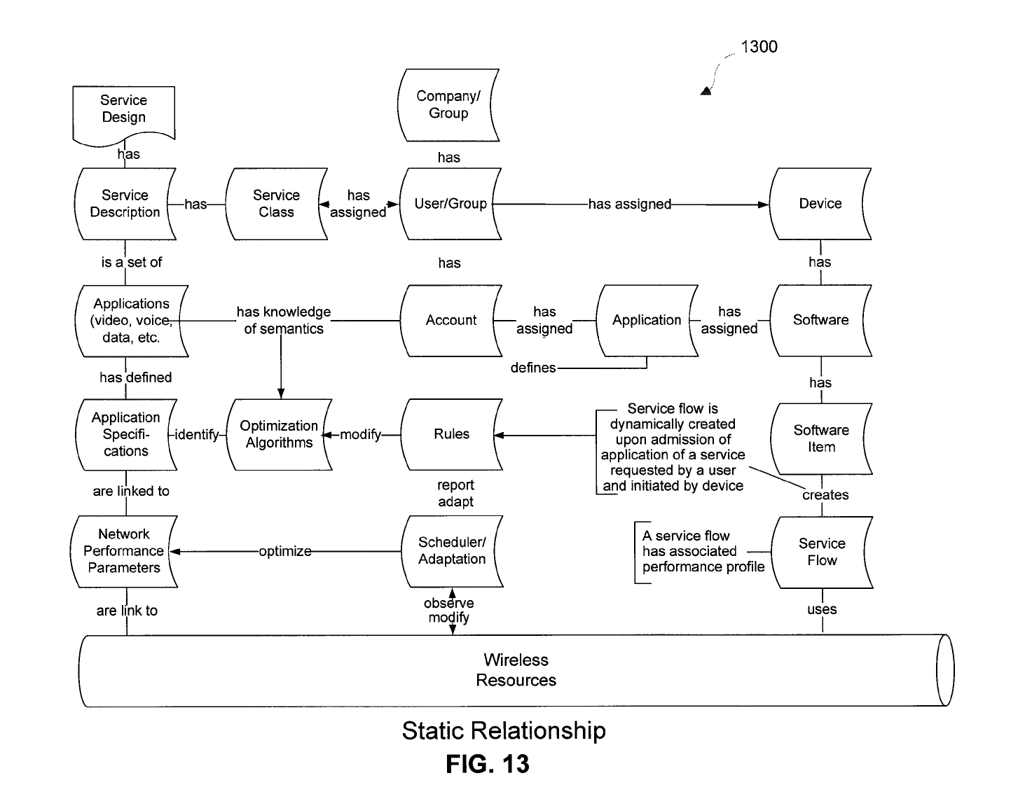

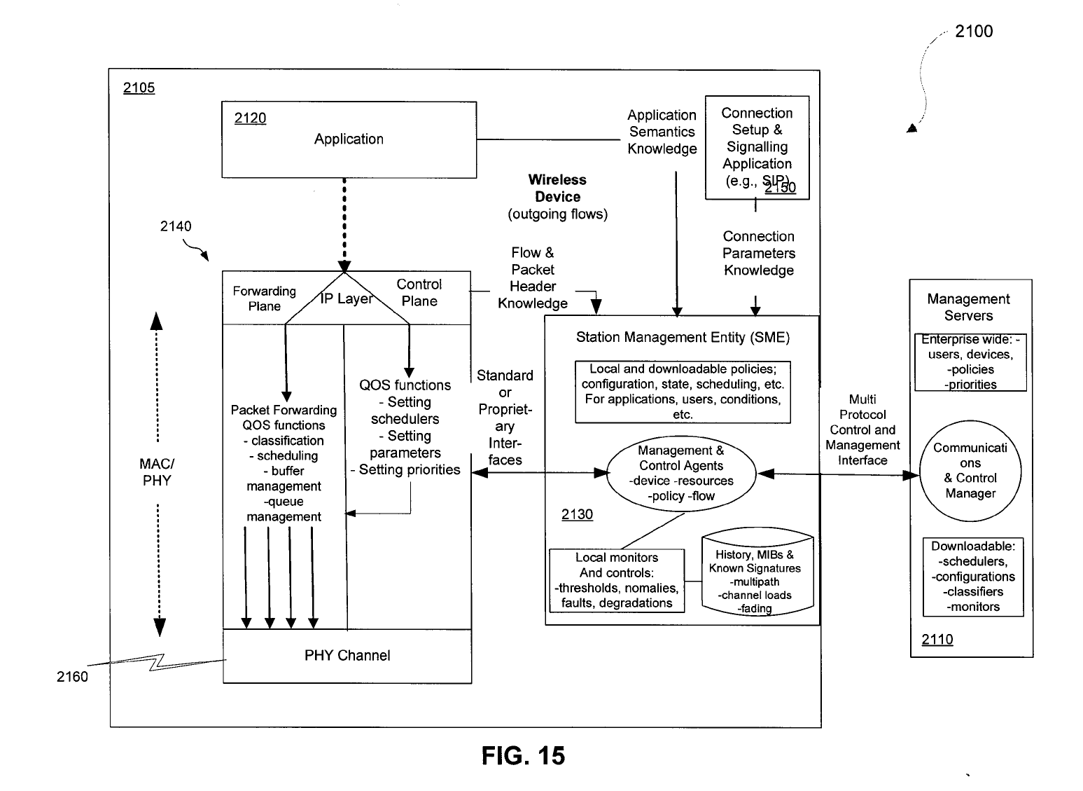

Attention is now drawn to FIG. 12 which illustrates one embodiment of EWM sequential functions and process as provided in a representative EWM system managing a wireless network. As shown in FIG. 12, the administrative process begins with a user/device administration step 1210. This step is associated with identifying and configuring the system, typically as a CIO function. The particular service is then configured in step 1220, also an administrative function. Service to end users are configured/provided in steps 1230-1250. The wireless system is first provisioned in step 1230, where, for example, conditions of service are provided, service is established, etc. The service may then be activated at step 1240, for example, the network is started or turned on. Devices/users may be admitted to the network as well as being rejected and/or having rejections handled. Finally, normal runtime operation is done at step 1250 based on the particular provisioned and established services. Runtime management may also be provided in step 1250. It will be noted that the value of any management services is provided only to active, enabled users, i.e. to users and associated devices configured and managed by the network. FIG. 14 provides a more detailed description of this process for one exemplary embodiment of the present invention, where administrative and configuration processes are illustrated at the top and the provisioning process is illustrated below.

One illustrative example is encrypted service flows of a virtual private network (VPN) service. These service flows are products of the components present in the user devices, performing encryption or decryption at the edges along with quality-of-service (QOS) algorithms and schedulers performing QOS management in the intermediate network elements.

It will be apparent that particular services have unique requirements. For example, in video applications color depth may be more important than frame rate to some users, while for other users the preference may be the other way around. In some applications time delay or lack thereof may be important. For example, some applications may be delay sensitive and can tolerate errors, and some other may not tolerate errors but may tolerate delays.

As shown in FIGS. 12 and 14, instances of object classes such as those described previously can be created/edited/deleted manually by a system administrator or a user as an administrative function, based on established policies and privileges to tailor these services for a specific user or application instance. Other objects enabling communication services, such as service flows, connections, etc. may be created/modified/deleted automatically on either pre-provisioned or ad-hoc basis, and are components of runtime service as part of EWM automated functions as illustrated in FIG. 12.

Therefore, in some embodiment of the present invention an EWM will allow a system administrator or other authorized user to configure the service (pre-designed by using industry specific templates and default configured) for the needs of its users and applications, and to define how the particular user/application will need to adapt under overload or suboptimal network conditions, or under different context or other operational criteria. Each user or application may have a list of alternative specifications, and associate a utility value with each specification. This may be based upon a list of alternative specifications, with associated context, priority value, or performance metrics for each specification.

All the required components may be linked to form a specific service configuration. It could a row in a table, as illustrated below. Examples of IDs values shown in the tables below are only provided for the purpose of illustration, not limitation. Real values in a particular embodiment may need to comply with standard syntax and terminology.

TABLE 1
Example of Service Configuration

| UserID | AccountID | SeviceID | DeviceID | ApplicID | ProfID | RuleID |
|---|---|---|---|---|---|---|
| Joe Doe | B162552 | premium | Vt1001-02 | Voice01 | QOS01 | Rule02 |
| M32416 | 6479229 | basic | M35890 | Voice04 | QOS04 | Rule11 |

Each of the fields/components in the service configuration can be expanded further to include additional characteristics associated with the particular service or services provided. For example, a performance profile may include a combination of specific parameters, as shown in the table below. Individual ProfID entries may have different values/specifications for included parameters.

TABLE 2
Examples of Profile Definition

| ProfID | ServClass | TrafcPriorty | MaxDataRate | MinDataRate | MaxDelay | . . . |
|---|---|---|---|---|---|---|
| QOS01 | Pv001 | 7 | 64000 | 8000 | 80 | |
| QOS04 | Pv003 | 4 | 32000 | 4000 | 120 | |

Providing customized user/application services requires that different components with different characteristics be placed appropriately in the network and devices for a specific service instance. Service design/configuration specifies the components required by a service and how to link/relate them. The outcome is a creation of a service flow. A service flow may be a row in a service flow table as illustrated below.

TABLE 3
Example of a Service Flow

| SerFlowID | MACaddr | Direction | State | ProfID | ItemID | . . . |
|---|---|---|---|---|---|---|
| 34166546 | 00:60:21:A5:0A:23 | 1 | 3 | QOS01 | S2201 | |
| 14563289 | 00:60:21:A5:0A:57 | 2 | 1 | QOS04 | S1008 | |

Among others, as shown in this example, a service flow may be associated with a specific device (MAC address), pointing to a specific performance profile, or other parameters. In addition, a service flow may be assigned a specific state, such as (pre) provisioned, admitted, active, or other specialized or conditional states. However, service flows may be associated with other objects, and identified by other IDs.

In addition, specialized schedulers (identified to DM as ItemID) may me be assigned dynamically to a service flow DARM System and Process. A specific scheduler may be a set of parameters with specified max/min values and packet handling policies. The table below illustrates a possible definition of scheduler.

TABLE 4
Example of Scheduler Definition

| ItemID | MinRsrvRate | MaxSustRate | MaxDelay | GrantSchdType | RxTxPolicy | . . . |
|---|---|---|---|---|---|---|
| S2201 | 8000 | 64000 | 150 | 4 | 6 | |
| S1008 | 400 | 1200 | 2000 | 6 | 3 | |

A service deployment/provisioning process may then perform the actual mapping of these defined components into the network, devices, and other objects as described elsewhere herein.

In a typical embodiment, both global (end-to-end) and local (link, device) knowledge related to service flow may be required. This knowledge is acquired through one or more of the interfaces: An application semantics knowledge interface; A flow, frame, and packet header knowledge interface; A connection parameters/information knowledge interface; An OSI Layer 2 and Layer 1 management and control interface (e.g., MLME SAP); A Multi protocol management and control interface; or other similar interfaces.

In a typical embodiment an EWM resource manager (RM) is provided. The EWM RM is focused on management of wireless link performance, an in particular the weakest and most unpredictable links in the end-to-end architecture, to ensure that end-to-end performance meets specified service classes and performance limits. Therefore, once service is configured and running, the RM continuously operates to optimize service performance in real time and adapt network configurations and performance based on specific context.

This may be accomplished by utilizing local and global schedulers and boosters (i.e. device software items). A global scheduler job may be used to divide tasks among network components according to rules and performance metrics, and to provide global knowledge about service flow. A local scheduler/booster may be provided to focus on local optimization, which is typically targeted to a single node or single parameter. The local scheduler/booster is typically performing such optimizations continuously and in real time.

The combination is a priori unknown, because users may install applications dynamically and the networking environment may changes (for example, due to device and/or terminal mobility). Thus the schedulers/boosters have to be updated continuously or periodically accordingly to support a specific combination provided by global scheduler. As described in further detail below, DARM systems and processes may be provided and assigned responsibility for management of these dynamic configurations.

Dynamic and Adaptive Wireless Network Management

Another aspect of wireless resource management is related to dynamic and adaptive wireless network management, including a software architecture and functions that enable dynamic and adaptive management of wireless networks and their resources, typically in wireless packet networks, according to rules, policies, quality of service (QOS) requirements, and other requirements driven by users, applications, and conditions.

In some embodiments of the present invention a dynamic and adaptive resource manager (DARM) system comprised of one or more modules may be provided to manage and control multiprotocol wireless network resources (including access points, repeaters, & distributed antennas) dynamically and adaptively. DARM real time management functions may include the following as well as others: performance optimizations; interference avoidance; quality of service (QOS) management; as well as other specialized applications, functions, and techniques. Among other functions, DARM management functions may include predicted and real time adaptation to location and proximity based parameters of the network.

In order to further describe DARM functionality it is helpful to consider programmable networks and associated abstractions. Traditionally, active or programmable networks have been proposed to accelerate the introduction of new communication services and to cope with the pace of network evolution. The concept of programmable networks or network elements assumes that two types of network element components exist: control elements (CE) in a control plane, and forwarding elements (FE) in a forwarding plane (or data plane). Forwarding elements are typically ASIC, network-processor, or general-purpose processor-based devices that handle data path operations for each packet. Control elements are typically based on general-purpose processors that provide control functionality, such as routing and signaling protocols and the like.

To enable open/standard programmability it is helpful to abstract the networking hardware, and include environments to download and install the networking software above the hardware abstraction level, because programmable networks usually assume the existence of a common abstraction of the underlying hardware. In embodiments of the present invention both standard and proprietary abstractions of resources may be used. These may differ for each radio type and are often tightly coupled to dedicated hardware. In some exemplary embodiments proprietary networking software environments are used that may be downloaded and installed above the hardware abstractions if standard and open resource abstractions are not available. When proprietary interfaces to the managed resources are used, they may differ for each device type and often need to be tightly coupled to dedicated hardware.

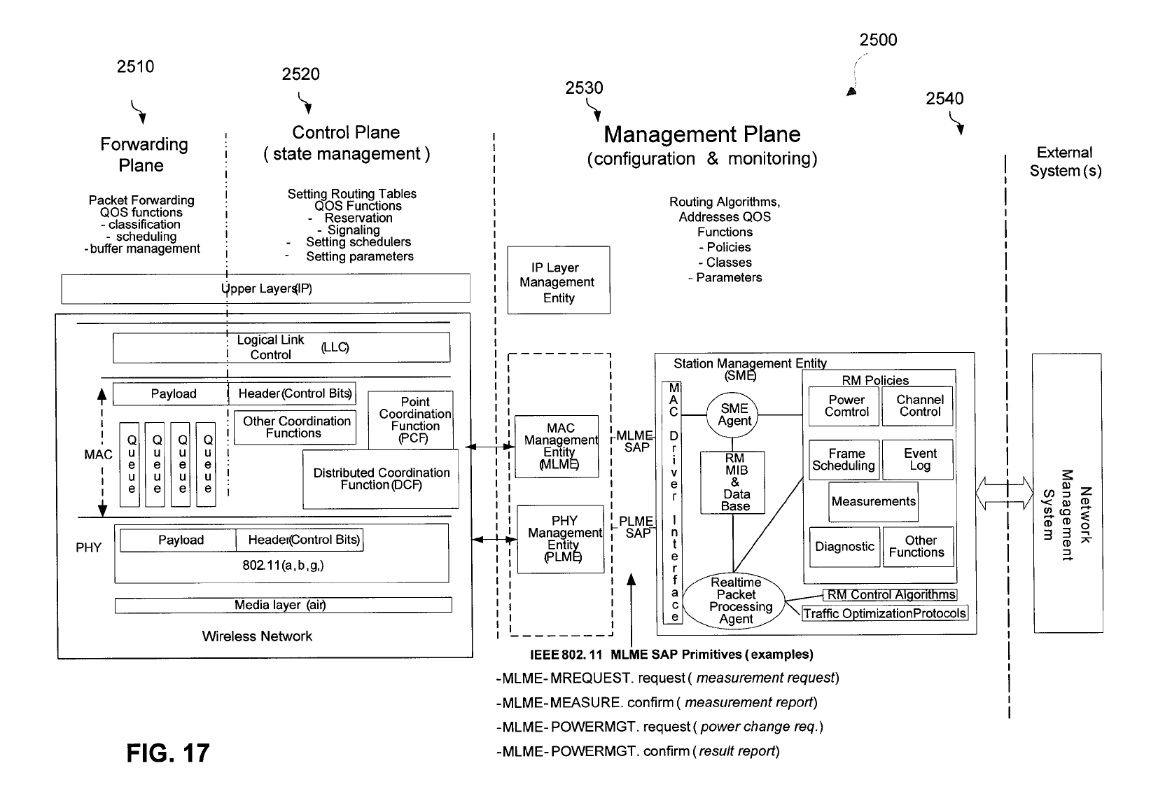

In many devices resources such as processing power and memory are limited. To overcome the problem of limited resource availability on a device, dynamic software updates may be used for re-configurable devices, where protocol modules are downloaded to update or extend the existing code. A device management client in coordination with a communications and control manager may be used to perform such procedures. Alternately, a station management entity (SME) proxy appliance architecture as is further describe below and shown in FIG. 16 may be employed to overcome resource limitations and/or to increase DARM performance.

For a typical wireless device there may be multiple management and control clients present. These may exist as a set of functions implemented in software, firmware, or software and hardware combinations or modules of various types. Functions may be implemented as a set of specialized clients, which typically will reside on an SME, or on other system and/or device components as dictated by the specific performance, functional, and architectural requirements. In typical embodiments agents are responsible for monitoring local resources on a device, reporting back to a management and control manager, and performing requested actions by this manager. Major functions of agents include but not limited to: Monitoring wireless network resources, such as bandwidth, RF signal strength, noise level, QOS parameters, roundtrip times, signal path loss, and others, including location based measures and the like; Applying various algorithms and techniques to process information and predict the future state of network resources; Mapping policies and profiles to available resources; Allocating and reserving local resources to provisioned flows; providing feedback on critical resources to higher level managers; Employing various optimization algorithms and techniques to dynamically adjust to channel condition; as well as a variety of other functions and processes including those described elsewhere herein. Embodiments of aspects of DARM system configuration and functionality are further described below.

In some embodiments a resource management client (RMC) may be assigned responsibility for monitoring local RF resources on a device, reporting information back to a resource manager (RM) and performing actions requested by the RM. The RMC may be tightly coupled with device resources to enable real-time reporting and control of local RF resources on a particular device. Additional specialized agents may also be used by the management system to perform more advanced and specialized functions, such as trajectory or interference management.

In some embodiments a semantics interface may be provided. This interface may be used to provide access to an application's semantics knowledge (i.e. to obtain knowledge of the applications used). Understanding of application semantics may allow additional performance optimization of particular transmitted streams. For example, it will be recognized that for multimedia applications such as voice or video the loss of some packets may have more significant impact on the perceived quality, as not all the packets have the same importance for objective speech or video quality.

As another example, given speech signal properties and low bit rate codec features, it may be possible to distinguish between important and unimportant packets. Once such semantic knowledge is obtained, one or more application optimization agents may be used to mark these packets according to their importance in the same flow. The application optimization agent may then apply a proper scheduler function to mediate an access to the shared RF transmission channel for multiple flows produced by multimedia applications, including the possibility of treating packets individually within a single flow, as well as dynamic adaptation to the particular channel state.

In some embodiments this functionality may be performed by enhanced Link/MAC Layer functions capable of influencing the quality of the transmission of the radio channel, by, for example, adjusting the transmission power, usage of multiple antennas (MIMO), beam forming/steering, of other similar channel control/performance enhancement techniques. In some exemplary embodiments this may include selective packet loss recovery to protect packets by using different configurations of the physical and data link layer and switching between them on a per-packet basis. Another approach may be applied using redundant transmissions and packet duplications to protect the packets classified as important.

In some embodiments, the implementation of the application optimization function may include software modules interfaced to a transmitting side, located on a mobile device, and to a receiving side, located on an access point. Both modules may be located at the MAC- and link layer, and they can be pre-installed on devices, or dynamically deployed to support a specific instance of a flow using systems and techniques as described herein.

In some embodiments there may also be a flow & packet header knowledge (FPHK) interface to the control plane and control element(s). The purpose of this interface is to obtain flow and packet knowledge available in the header of the packet or frame of higher layers of the OSI stack (i.e., Layers 3 through 7). This knowledge may be used by DARM agents and management and control applications to manage the flows and packets according to established rules, policies, and conditions.

In some embodiment there may also be a connection and signaling knowledge (CSK) interface. The purpose of this interface is to obtain connection knowledge information available in connection establishment and signaling messages. This knowledge may be used by DARM agents and management and control applications to manage the connections and flows according to established rules, policies, and conditions. This information may also used to trigger management and control events associated with the knowledge, such as, for example, identifying the establishment and termination of a connection.

Embodiments of a DARM system will typically include management servers that contain enterprise wide policies, priorities, and conditions for users, devices, and applications. Management servers may also store and manage downloadable schedulers, configurations, classifiers and monitors as well as provide other functions as described elsewhere herein.

In some embodiments interactions and communications between management and control agents and management servers may be performed using a multi-protocol control and management interface, managed by a communications and control manager as described elsewhere herein. In a typical embodiment the manager is a central part of DARM. It may be configured to interact with “conditional” provisioning functions to maximize resource efficiency (access points, routers, & repeaters) and manages activities and functions of agents, including the selection of the specific agent to be used, to ensure that enterprise wide requirements and policies are met.

The management and control manager may be provided as a software application/controller/module that may be deployed at an access point, base station, router, repeater, smart antenna system, proxy appliance, central server/controller, or other network node as dictated by the specific use case or performance requirements.

As noted previously, a DARM system may include management servers as well as one or more management and control agents. As used herein, agents are software clients/modules deployed on the wireless devices or in conjunction with a wireless proxy appliance which may be used in the event there are insufficient processing or memory resources to support the control agents on the network and client devices. Multiple agents may be present on a single device. A proxy appliance may likewise manage and control multiple wireless devices. Each agent may be assigned responsible for a specialized management and/or control function, such as device management, radio resource management, application performance optimization, or other aspects of device operational or performance management.

In some embodiments enterprise wireless management servers may be remotely located and may include profiles, policies, priorities, and associated contexts for the enterprise users and devices. In addition, management servers may have downloadable software modules such as schedulers, configurations, classifiers, monitors, and the like that can be dynamically uploaded to wireless devices as described herein.

In some embodiments a station management entity (SME) may be provided to represent management and control capabilities present locally on a device, or on a SME proxy appliance. In addition to management and control agents, local policies, monitors, MIBs, and other management capabilities may be present on an SME.

In some embodiments there may also be an interface to an application or applications for obtaining knowledge of application semantics. Knowledge of application semantics may be used as described elsewhere herein to optimize performance and quality of application transmission over the media channel. Specialized classifiers and schedulers may be employed to perform such optimizations.

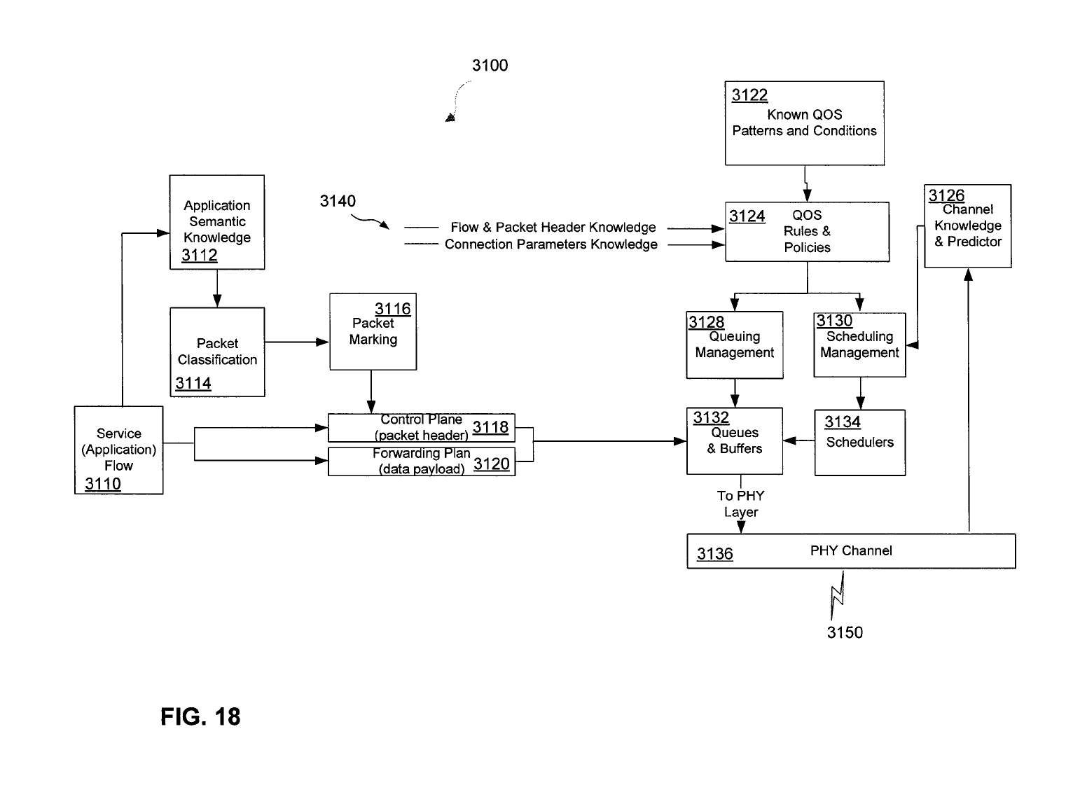

Management and control agents may communicate with the MAC/PHY control plane of the device using either standard or proprietary interfaces, APIs, or messages. As an illustrative example, an embodiment employing the IEEE 802.11 standards define them as MLME-SAP and PLME-SAP, with corresponding messages, as shown on FIG. 17.

Management and control agents may communicate with one or more communications and control managers present at management servers using multi-protocol control and management interfaces and messages. Both standard and proprietary protocols and messages may be used by this interface. Embodiments of multi-protocol systems and and methods are provided in later sections herein.

In one exemplary embodiment a DARM System includes the following components in the form of hardware, software, or combinations of hardware and software: means for accessing wireless network resources, typically via an interface or API; One or more management and control clients, including a resource management client (RMC); One or more communications and control managers, including a resource manager (RM); A multi protocol control and management interface; management servers with downloadable management modules; One or more preprogrammed rules engines to control the application of RMC to network devices; One or more listeners to constantly monitor network and client connectivity behavior and performance, among other parameters.

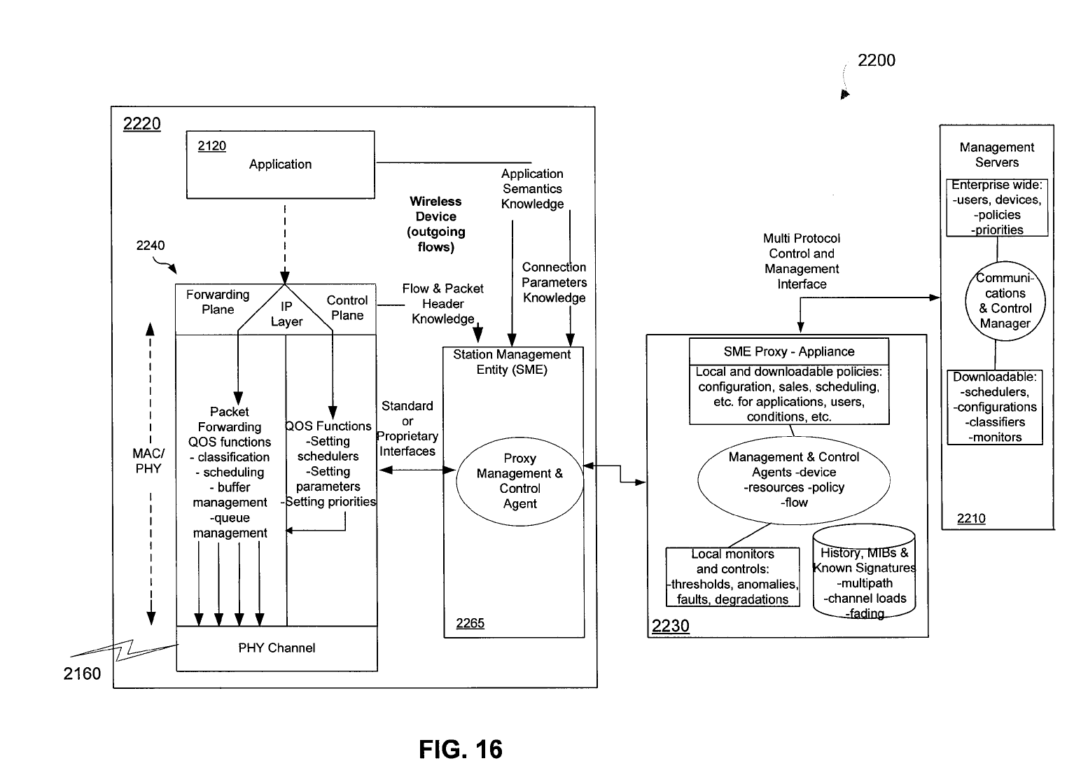

The above embodiments of the present invention, as well as additional aspects, are further illustrated with respect to the figures. FIG. 15 illustrates a representative DARM architecture 2100. A DARM system may comprise multiple applications/functions/devices such as are described below in the form of software applications, modules, software and hardware combination applications/modules, or other means of providing functionality as are known in the art. Functionality may be distributed over multiple devices, such as over a management server 2110 and wireless device 2105 as shown in FIG. 15. A wireless device 2105 may include modules implementing multiple functions. One or more applications 2120 may provide information to the OSI MAC/PHY layer 2140 for wireless transmission over a wireless channel 2160. A station management entity (SME) 2130 may receive information such as flow and packet header knowledge from the MAC/PHY layer 2140, application semantics knowledge from application 2120, connection setup and signaling information from a setup application 2150 such as a SIP, and multi-protocol information from one or more management servers 2110.

A separate management server 2110 may be included in a DARM system either locally or remotely to provide enterprise wide management functionality including managing users, devices, policies, priorities, and any other related management or control functionality. Management server 2110 may also comprise downloadable modules such as schedulers, configurations, classifiers, monitors, or other downloadable functions or features. Management server 2110 may also comprise a communication and control manager configured and operative to communicate with one or more SMEs, such as via a multi-protocol interface as shown in FIG. 15.

As shown in FIG. 15, an SME 2130 may include one or more modules to implement functionality including managing local and downloadable policies, configuration, state scheduling, and other functions for applications, users, conditions, and the like. The SME 2130 may implement and/or provide one or more management and control agents related to devices, resources, policy, flow, and other related parameters. In addition, the SME may include local monitors and controls, threshold setting/detection, anomaly settings/detection, faults, degradations, and the like. Information related to historical performance may also be provided including known signatures, multipath, channel loads, fading, and other related information.

In some embodiments, a DARM System may alternately employ an SME proxy appliance architecture as shown in FIG. 16 to run some applications and functions in separate modules, hardware, co-processor(s), or “dongles.” It will be noted that many of the components/modules shown in FIG. 16 may be interchanged with the analogous component/module as shown in FIG. 15. As shown in FIG. 16, a wireless device 2205 including one or more applications 2220 may offload some functionality to an SME Proxy Appliance 2230, wherein functionality similar to that implemented in SME 2130 as shown in FIG. 15 is implemented. The wireless device 2205 may include a proxy management and control agent within a station management entity 2265, which is configured to communicate with SME proxy appliance 2230. The wireless device may also include an OSI MAC/PHY module 2240 configured to communicate with a wireless channel 2160.

FIG. 17 illustrates one embodiment of a DARM system 2500 in the context of an 802.11 network. Forwarding plane 2510 modules address packet forwarding functionality including physical signaling via the transmission channel, quality of service functions related to classification, scheduling, buffer management, and other related functionality. Control plane 2520 modules address state management functionality including setting routing tables, QOS functionality related to reservation, signaling, setting schedulers, setting parameters, and related functionality. Management plane modules 2530 address configuration and monitoring functionality including routing algorithms, addresses, QOS functions related to policies, classes, parameters, and related functionality. An interface is provided to external systems 2540, such as an external network management system.

Quality of Service (QOS) Management

Another aspect of the present invention is related to management of wireless network quality of service (QOS). As noted previously, a number of problems exist with respect to quality of service management in current wireless networks. For example, existing QOS management of packet based transmission systems typically include packet classification, marking, queuing and scheduling. These processes are static and not very granular.

Scheduling in wireless networks may require different approaches from those used in wireline networks, as the capacity/bandwidth of the link varies in time, depends on location, and is subject to other environmental conditions. In addition, most of the existing scheduling algorithms assume some type of channel conditions, without a real knowledge of the channel's true conditions, thus potentially making these algorithms ineffective, and sometimes even counterproductive. Typically these algorithms are “hardwired” into the wireless device, such as in a base station or access point device. In wireless networks, network configurations and topologies may be not know a priori, as in the case of ad hoc networks, or may be changing as mobile nodes are moving, appearing, and disappearing from the network.

In one aspect, the present invention relates to addressing these problems as well as other through the use of dynamic and efficient management of deterministic/guaranteed QOS. As used herein, QOS may be defined as a set of elements/parameters describing expected and/or required network resources, such as bandwidth, data rate, delay, jitter, error rate, and the like. QOS requirements may be expressed in different terms and at different levels than network resources. However, all of them need to be translated/mapped to manageable network resources. This requires specialized algorithms and tools at various levels of the OSI stack.

Deterministic or guaranteed QOS is hard bounded, and typically QOS calculation is based on upper bounds (worst case) and must be satisfied for a duration of service/session, even under the worst case conditions, thus ensuring high reliability of service. One alternative is a static reservation of resources, or overcapacity, which can lead to poor network utilization and lack of efficiency. This approach may work well for static networks such as wireline LANs, but it typically will not work well for networks with dynamically changing configurations and unpredictable performance characteristics, such are experienced in WLANs.

Some representative examples of unique conditions of wireless networks include the characteristics that as nodes move in and out of range of other nodes, the connectivity and network topology may change dynamically, and communication between mobile nodes requires that the received signal strength be adequate to connect to another mobile node at a specified QOS level.

In order to address these and other concerns, embodiment of the present invention manage and control wireless network resources dynamically and in real time, including performance optimizations, interference avoidance, quality of service (QOS) management, and other specialized applications and techniques.

In some embodiments, a QOS management system (also denoted herein as a QOS system) may be a component of an EWM system as discussed previously. In addition, in some embodiments a QOS management system may be a component of a DARM system as also discussed herein. One representative embodiment of QOS functionality within a DARM system is shown in FIG. 15.

In some embodiments a QOS system may include one or more elements including a QOS agent or agents, a QOS manager or managers, as well as other objects, components, and subsystems as described herein. In embodiments wherein a QOS system is a component of a DARM system, as discussed in further detail previously, the DARM system may include management servers and a number of other management and control agents, in addition to one or more QOS agents. Agents as defined herein are software clients/modules deployed on wireless devices, and multiple agents may be present on a particular device. Each agent may be assigned responsibility for a specialized management and/or control function, such as device management, radio resource management, application performance optimization, QOS management, and the like. A QOS agent may be implemented as a standalone software module or may be part of other management and control agents, or may be a set of specialized agents. A QOS manager may be provided as a software component of EWM servers such as are shown in FIG. 9.

In some embodiments, a QOS Management Process may include packet classification, marking, queuing, and scheduling. A QOS Management System may employ techniques described herein, in addition to standards based techniques, for these functions.

In some embodiments these techniques are dynamically applied to the QOS Management Process. In addition, fine granularity of QOS management, rather than coarse as is typical in wireless networks, where each packet within a session/flow is assigned a certain priority level and is managed accordingly to this priority may be employed.

In some embodiments, a QOS management system may utilize one or more of the following DARM interfaces or equivalent interfaces: Application Semantics Knowledge (ASK) interface—the purpose of this interface is to obtain semantics knowledge of the applications used; Flow and Packet Header Knowledge (FPHK) interface to control plane and control element—the purpose of this interface is to obtain a flow and packet knowledge available in the header of the packet or frame of higher levels of the OSI stack (i.e., layers 3 through 7); Connection and Signaling Knowledge (CSK) interface—the purpose of this interface is to obtain connection knowledge information available in connection establishment and signaling messages.

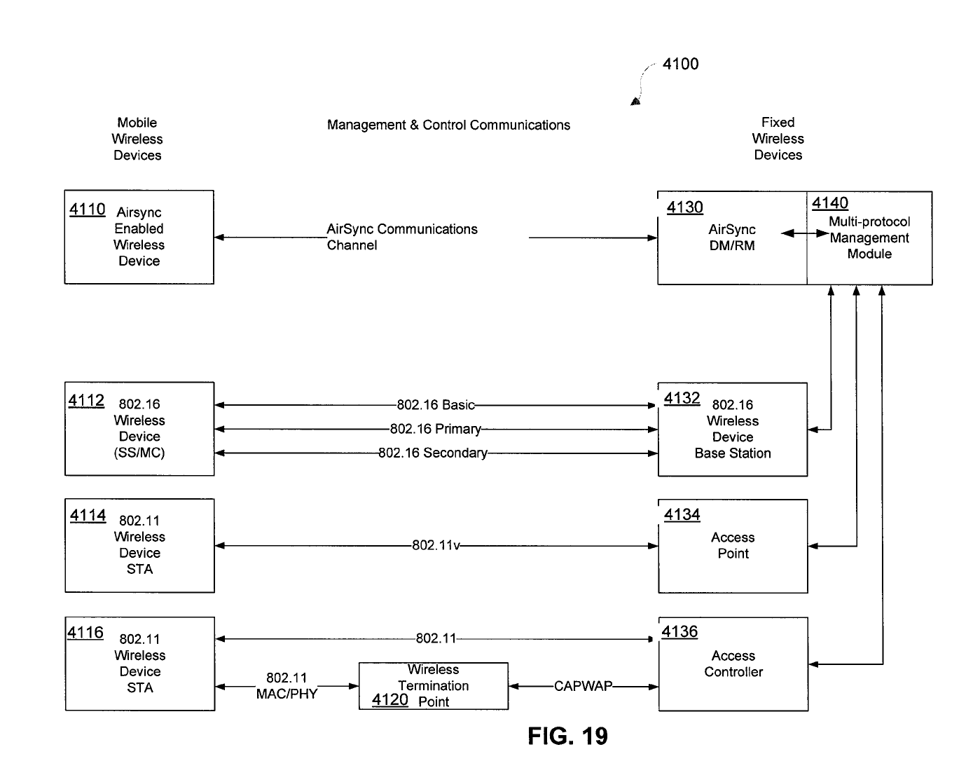

Attention is now directed to FIG. 18, which illustrates an exemplary embodiment of a QOS management system architecture and process flow. As shown in FIG. 18, a QOS management system may comprise a number of modules including hardware, software, or a combination of hardware and software, configured and operated to implement QOS functionality such as data processing, storage, and transfer. The modules may comprise process steps and/or associated hardware or software to implement such steps. Such modules may interface with other modules to control operation and implement data and/or control transfer between modules as well as external devices.

A QOS management process may start with an understanding of application semantics as shown in step 3112. Semantics knowledge may be provided via an application semantics interface from a DARM system or equivalent as discussed elsewhere herein. This allows for granular and more intelligent QOS performance optimization of the transmitted data streams. For example, in a network configured for optimization based on transmission of multimedia such as voice or video, it will be recognized that loss of some packets may have more significant impact on the perceived quality, as not all the packets have the same importance for objective speech or video quality, and therefore less important packets may be disgarded and/or assigned a lower transmission priority. In speech transmission applications it is known in the art that not all the packets have the same importance for objective speech quality. This provides a basis for network tailoring through QOS management to optimize performance. Considering the properties of speech signals and low bit rate codec features, processing based on this semantics knowledge may be implemented to distinguish between important and unimportant packets, and the important packets may be processed and transmitted while less important packets may be delayed or discarded, effecting improved quality of speech within a network while minimizing transmitted information. This approach can be implemented to improve perceived quality of speech transmitted through the network, and can be applied to other tailored applications wherein knowledge of application semantics may be used to process content accordingly.

Application semantic knowledge may be provided through a DARM system and may be used to obtain application somatic knowledge (i.e., important voice packets, important video packets, etc.), and to identify and classify relative importance of each packet in the flow such as is shown in 3114 in FIG. 18. This may further be done in addition to relative prioritization of the flows (ie. data vs. voice vs. video), that can be obtained through a Connection Parameters Knowledge (CPK) interface as well as through a Flow and Packet Header Knowledge interface of the DARM system as shown in interface 3140. The packets may then be marked accordingly at 3116 for transmission over the network at 3118, 3120, 3132, where they are transmitted through the PHY layer channel at 3136 to the wireless channel 3150.

A module 3110 may be provided to manage application service flow. Service flow module 3110 may provide information to application semantics knowledge module 3112 based on particular application information or quality of service criteria. Information may also be provided to the control plane 3118 (control/packetization information) and forwarding plane 3120 (data payload information) to be used in conjunction with information/data from other modules to generated data payloads and associated packet headers.

One or more modules 3124 may be provided to manage QOS rules and policies. Input to this module may be provided from a variety of interfaces/modules, including from interface 3140, as well as from a module or modules 3122 providing known QOS patterns and conditions. QOS rules and policy module 3124 may then provide information to a Queuing management module 3128 for managing queuing in one or more associated queues and/or buffers 3132, where content provided from the control plane 3118 and forwarding plane 3120 may be provided to be queued for transmission. Module 3124 may also provide information to a scheduling management module 3130, wherein data scheduling is managed via one or more schedulers 3134. Schedulers 3134 may provide scheduling information to queues/buffers 3132. Packetized data may then be transferred from queues/buffers 3132 to a PHY channel module 3136 wherein packets are transmitted on wireless channel 3150.

It will be further noted that application of QOS rules and policies may be done in a variety of ways. For example, application of QOS rules and policies may be be applied to each marked packet within a flow (i.e., a voice or video flow), in addition to or instead of application of per flow QOS rules and policies.

Another aspect of QOS management is related to adapting data transmission by using channel aware scheduling. It is know in the art that when transmitting applications over a wireless channel, multimedia traffic is faced with the error prone, time-varying nature of wireless communication. Multimedia applications may be particularly susceptible to degradations associated with channel variations.

This problem can be addressed by tailoring transmission to the measured, known, or predicted state of the channel. For example, in some embodiments of QOS management, this situation may be improved by adapting the transmission decisions (e.g., time to transmit or parameters like transmission power or FEC to the current) to the actual state of the wireless channel by using channel-aware scheduling. Channel-aware scheduling is a technique that adapts the transmission start time of a packet to the channel condition. Sending packets over a channel when the channel is in an undesirable state is avoided as the data would likely get lost anyway.

To make such decisions, knowledge about future channel state is needed. This knowledge may be obtained from channel prediction algorithms based on mathematical models such as are known in the art, and/or available from multiple sources and applied to known, measured, or predicted channel characteristics and associated application requirements.

In some embodiments of the present invention a QOS management system in accordance with aspects of the present invention applies a scheduler function to mediate access to the shared RF transmission channel for multiple flows produced by multimedia applications, including in some embodiments treating packets within a single flow individually, as well as applying dynamic adaptation to the channel state.

This may be performed by implementing enhanced Link/MAC Layer functions wherein the functions are capable of influencing the quality of the transmission of the radio channel by, for example, adjusting parameters such as the transmission power, usage of multiple antennas (MIMO), beam forming/steering, or other techniques for channel control and adaptation know in the art.

In one embodiment this process may include selective packet loss recovery to protect packets by using different configurations of the physical and data link layer and switching between them on a per-packet basis. Another exemplary approach may use redundant transmissions and packet duplications to protect the packets as classified based on their importance.

In some embodiments, QOS rules and policies may require a specific queuing and scheduling mechanism, in addition to, or in replacement of, per flow queuing and scheduling mechanisms that may need to be invoked for a managed flow instance. In embodiments using a DARM systems, the DARM system may be assigned responsibility for dynamic management (deployment and installation) of these mechanisms.

Another aspect of QOS management is related to proactive and predictive QOS management as further described below.

As noted and further described elsewhere herein, in an embodiment using a DARM system, the DARM system, through its interfaces, may passively monitor and records real network patterns (traces), such as for flow, traffic, conditions, and the like, apply trigger and threshold conditions, and then associate a particular QOS failure or performance degradation to a known and repeatable network condition. Specific rules, produced a priori and off-line, for these known patterns may be provided to QOS Manager as a part of the DARM system. In addition, self-learning and adaptive techniques may be used over the life cycle of network management to enhance and tune the reliability and precision of these tools. The system may be configured and operative to analyze historical results of transmission types, associated QOS mandated responses, and intervention results to better categorize thresholds and threat to QOS profiles, and accordingly optimize RM responses.

For example, in one exemplary embodiment a QOS agent in cooperation with a QOS manager manages QOS performance proactively based upon knowledge of these known traffic flow patterns (usage peaks, static connections, etc.) as well as known network performance problem areas (known poor coverage areas, high interference, etc.). Based upon knowledge of these known conditions, and by using pattern recognition techniques for boundary conditions, such as are known in the art, a QOS manager may proactively invoke specialized rules and/or schedulers, such as are discussed above and elsewhere herein, to manage QOS for identified flows.

In some embodiments, a QOS agent screens QOS related parameters against predefined thresholds and monitors their changes and behaviors. Continuous monitoring of QOS may be performed and aggregated, and analyzed feedback is provided to the QOS manger or management application to invoke rules and the desired modification to wireless and network settings. To accomplish this, a client device must be able to support QOS settings and their associated management. This may be accomplished by deployment of a software client to support both standard and proprietary communications, such as is described elsewhere herein.

In some embodiments, a “lightweight” version of QOS with lesser functionality may be obtained without the client application modification by network side analysis of invoked protocols and traffic patterns associated with device profiles. In this version, any ensuing analysis can likewise hit threshold trigger rules in the QOS manager and invoke the appropriate network management modifications.

It is typically also desirable to monitor and signal when a desired QOS level is not or cannot be maintained. Consequently, in some embodiments, QOS management functionality may include functions related to notification of inability to maintain a desired QOS level. When the QOS manager is not able, or is predicting that it will not be able, to maintain the required QOS level, it may notifies a QOS management application that is a part of EWM and/or DARM. The QOS management application may then provide specific instruction to the QOS Manager about any desired and/or required action. This action may be based upon “higher” level knowledge of the user/application priorities such as QOS requirements, network wide information, session relationships, and other related or similar priorities as predefined and administered by EWM and/or DARM.

Multi-Protocol Management

Another aspect of the present invention is related to multi-protocol management. As noted previously, a number of problems exist in typical wireless networks where multi-vendor devices operate in accordance with multiple protocols. In some aspects related to multi-protocol management, embodiments of the present invention are directed to software architecture and functions that enable dynamic protocol negotiations making network management and control applications and functions protocol agnostic.

Configuration management is one of the most complex and critical management activities to be performed on a managed device in a wireless network. Standard and legacy technologies such as SNMP, CLI, and the like are not very well suited for configuration management due their inherent limitations. In addition, these standard and legacy approaches are static and do not provide negotiation capabilities.

In some embodiments of the present invention, a fully or partially proprietary management system may be used. The management system comprises a management client embedded into the device environment (either directly, via APIs, via an associated dongle, or via other techniques known in the art including those described elsewhere herein) that enables efficient and powerful control over both standard and proprietary management interfaces.

Management applications and functions can use this management system to transparently manage devices over multiple management interfaces, both standard and proprietary. A strength of this approach is the ability to bridge multiple wireless and network protocols, using both standard and custom interfaces, to allow management of all resources from a single management point or application.

In some embodiments, access to managed wireless network resources may be provided via standard, open, or proprietary interfaces and APIs. A multi-protocol management and control communications layer may then be used to enable protocol agnostic execution of management applications, policies and functions, including optimizations performed by agents.

The following functions, as well as others, may be implemented to enable multi protocol management and control of heterogeneous devices: Protocol type negotiations to choose a specific type of protocol for a management function that is supported by the device; Capabilities negotiations to establish knowledge about specific profile and options that are supported by the device; Protocol configuration that is required to ensure interoperability; Protocol message mapping that may be required to ensure interoperability between management applications and functions and the protocol messages supported by the device; Information translation and adaptation that may be required to ensure that correct information is managed and controlled.

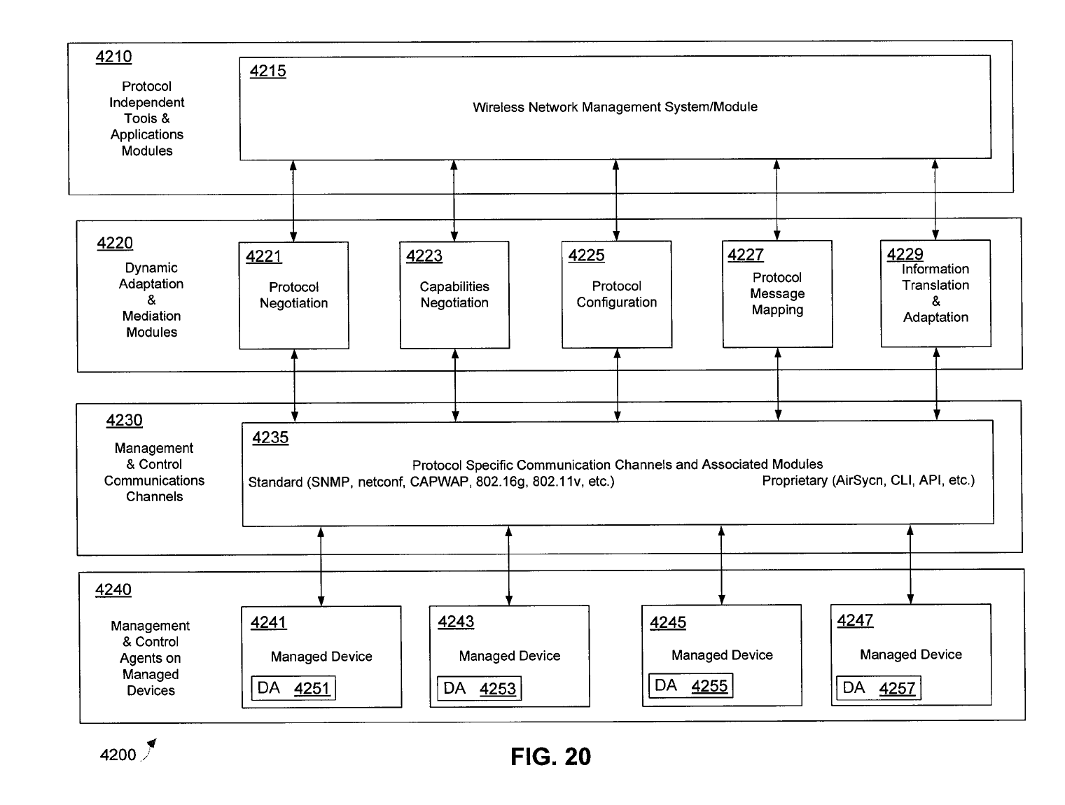

Attention is now directed to FIG. 19, which illustrates one embodiment of a multi protocol management and control communications layer used to manage heterogeneous devices. As shown in FIG. 19, a typical wireless network being managed according to a multi-protocol management system may comprise multiple mobile as well as fixed wireless devices such as mobile devices 4110, 4112, 4114, and 4116. The mobile devices may be configured to operate according to multiple wireless protocols such as IEEE 802.11 in various forms, IEEE 802.16, AirSync, or other wireless configurations or protocols. It will be noted that while the embodiment of FIG. 19 is shown with respect to these protocols, the invention is not so limited and other protocols are fully contemplated herein.

The wireless network may further comprise one or more fixed location wireless devices such as devices 4130, 4132, 4134, and 4136. These devices may be configured to communicate with the mobile wireless devices as shown in FIG. 19, or in other similar configurations with other wireless devices. Management and control of the multiple mobile wireless devices may be in accordance with recognized protocols such as those shown in FIG. 19 including AirSync, IEEE 802.11 basic, primary, and/or secondary, IEEE 802.11v, IEEE 802.11, or other protocols known in the art. In some embodiments a wireless termination point 4120 may be provided to enable interfacing between the 802.11 MAC/PHY layer and may use protocols such as control and provisioning of wireless access points (CAPWAP) to access controller 4136. Interfaces between fixed wireless devices 4130, 4132, 4134, 4136, as well equivalent devices in other network configurations may then be provided to a management and control communications layer module 4140, wherein multi-protocol management functionality may be implemented.

FIG. 20 illustrates one embodiment of an architecture implementing multi-protocol management and control of heterogeneous devices. As shown in FIG. 20, a set of protocol independent tools and applications 4210 may comprise a manager module or modules 4210 along with other modules, with the manager module used as a central element of a multi-protocol management and control system. Manager module 4210 may be configured and used to provide high level management functionality, independent of particular protocols. This may include a range of tools, functions and applications which may be provided by manager module 4210 alone or in conjunction with other modules, subsystems, or applications. Manager 4210 may interact with one or more “conditional” provisioning function modules 4220 to maximize resource efficiency (access points, routers, repeaters, smart antenna systems, specialized network appliances and end user wireless systems) by providing conditional provisioning, such as provisioning associated with particular device interfaces, protocols, and the like. Conditional provisioning modules may provide dynamic adaptation and mediation functionality within modules including modules configured to perform protocol negotiation 4221, capabilities negotiation 4223, protocol configuration 4225, protocol message mapping 4227, information translation and adaptation 4229, as well as other related functions. This layer may be used to provide an interface between protocol independent management functionality and standards based or proprietary based devices and their associated interfaces.

An addition level 4230 comprising protocol specific communications channels and one or more associated modules 4235 may be provided to manage and control communications channels based on particular device and channel requirements. This may include management of protocol specific communication channels based on standard (i.e. SNMP, netconf, CAPWAP, 802.16g, 802,11v, or other standards) or proprietary (AirSync, CLI, API, and the like) channels/standards. It will be noted that AirSync is a proprietary communication standard developed by Proximetry, Inc.

In addition, a management and control layer 4240 may be provided on managed devices to manage, control, deploy, and operate device agents 4251, 4253, 4255, 4257 and agent functionality on one or more managed devices such as managed devices 4241, 4243, 4245, and 4247 as shown in FIG. 20. Management may include the activities and functions of agents, including the selection of a specific agent or agents to be used, to ensure that established SLAs and QOS requirements are met. Agents may be deployed on multiple devices such as managed devices 4241, 4243, 4245, and 4247, these devices representing various types of wireless devices such as are shown in FIG. 19. It will be apparent that a wide variety of different managed devices may be provided/used.

It will be noted that manager module access (interface or API) to QOS profiles, SLAs, and policies may be provided via standard, open, or in some cases proprietary interfaces or APIs. In some embodiments the present invention uses proprietary interfaces if standard or open interfaces and APIs are not available.

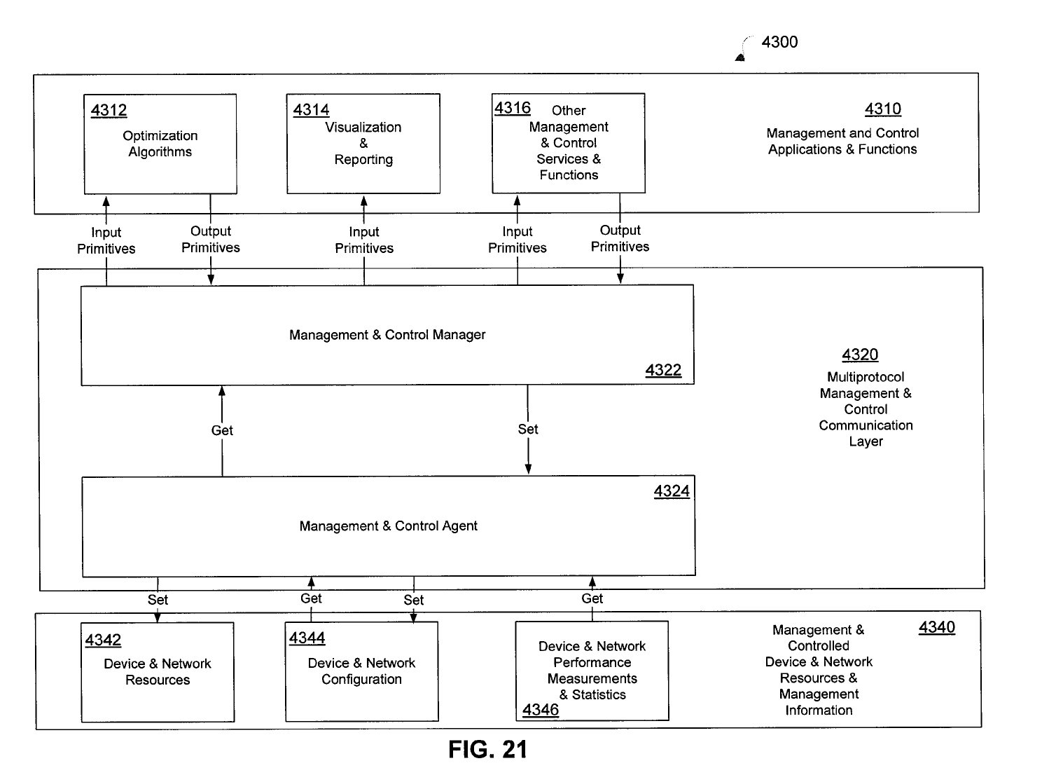

Attention is now directed to FIG. 21 which illustrates one embodiment of management architecture. In some embodiments, management and control clients are responsible for monitoring local resources on a device, reporting back to a management and control manager, and performing requested actions by the manager. These communications may be sets of simple operations performed on the managed resources. The names of these operations are typically protocols specific. For example, in FIG. 21 these operations are generalized to READ/WRITE operations described as GET/SET. Specific protocols may support other type of operations denoted differently such as DELETE, CANCEL, FILTER, or other protocol specific terminology.

Management and control functionality of the embodiment shown in FIG. 21 can generally be divided into three components comprising one or more modules based on software, hardware, or combinations of hardware and software. Management and control applications and functions 4310 may interact with a multiprotocol management and control communications layer 4320 which may further interact with specific network and device resources 4340 to provide multiprotocol network management functionality.

The information received/obtained from managed devices may be passed to management applications and functions as a set of primitives. The applications may then process these input primitives according to their computing logic. The output of these calculations may be provided to other higher level applications or may be provide as set of output primitives requesting specific actions, such as SET, on managed/controlled resources such as wireless base stations, access points, or other devices.

For example, as shown in FIG. 21, one or more modules implementing optimization algorithms 4312 may be provided to receive input primitives from a management and control manager module 4322 and may provide output primitives based on one or more optimization criteria. Input primitives may be provided to one or more modules 4314 to provide visualization and/or reporting information about various aspects of managed network operation. Additional management and control functions 4316 may be implemented to provide control services and functions. Modules 4316 may similarly receive input primitives from a management and control manager 4322 and provide output primitives based on their functionality.

Management and control manager 4322 may also interface with one or more management and control agents 4324 as shown in FIG. 21. Management and control agents 4324 may then interface with particular devices and/or other network resources based on device specific standards, configuration parameters, and the like. For example, a management and control agent may provide information to device and network resources 4342, may provide and receive configuration information from devices to configure network resources based on application or network specific requirements 4344, and may receive device and network information 4346 such as device and network performance parameters, measurements, statistics, or other device or network status, configuration, or operational information. Additional illustrative examples provide further details regarding embodiments of the invention.

### ILLUSTRATIVE EXAMPLE 1

### RF Interface Control

In an embodiment of a optimization application for RF interference control, the application may receive input primitives such as power/noise levels, error rates, or other parameters related to the RF channel or interface for its computational algorithm and associated processes, and then provide output primitives such as power level and/or channel number that will be need to be changed on the device by SET operations. For example, as shown in FIG. 21 the primitives associated with power/noise levels may be provided from manager 4322 to optimization algorithm module 4312, which then provides the power level, channel information, or other RF related parameters back to the management and control manager for further processing and/or transmission via agents to network resources such as base stations, access points, and wireless devices.

### ILLUSTRATIVE EXAMPLE 2

### A Reporting and Visualization Application

In an embodiment of a reporting and visualization application, the application may present received input primitives in a human readable format such as a text or graphical representation of the information and/or events, or information and/or data stored in one or more files in a computer readable/displayable/printable format. This may include information about particular device configuration, performance, transmitted or received data, overall network performance metrics, or other information related to device or network operation or data suitable for reporting or visualization.

In some embodiments, a management and control manager module or modules may be provided as a software application/controller that may be deployed within the managed network, such as at a base station, access point, router, repeater, smart antenna system, proxy appliance, and central server/controller, as dictated by the specific use case or performance requirements. In other embodiments, a management and control manager module or modules may be provided at a remote location such as on an EWM server or other remote system or device.

As noted previously, some embodiments of the present invention are directed to computer software and/or computer hardware/software combinations configured to implement one or more processes or functions associated with the present invention. These embodiments may be in the form of modules implementing functionality in software and/or hardware software combinations. Embodiments may also take the form of a computer storage product with a computer-readable medium having computer code thereon for performing various computer-implemented operations, such as operations related to functionality as describe herein. The media and computer code may be those specially designed and constructed for the purposes of the present invention, or they may be of the kind well known and available to those having skill in the computer software arts, or they may be a combination of both.

Examples of computer-readable media within the spirit and scope of the present invention include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code may include machine code, such as produced by a compiler, and files containing higher-level code that are executed by a computer using an interpreter. Computer code may be comprised of one or more modules executing a particular process or processes to provide useful results, and the modules may communicate with one another via means known in the art. For example, some embodiments of the invention may be implemented using Java, C#, C++, or other programming languages and software development tools as are known in the art. Other embodiments of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

I claim:

1. A system for dynamically managing quality of service (QOS) within a wireless network, said system comprising:
a plurality of QOS agents, each of said QOS agents configured to receive information from one of a plurality of wireless devices within said wireless network;
a QOS management module in communication with said QOS agents, said QOS management module operative to manage QOS of said wireless network based upon one or more QOS parameters; and
a wireless system management module disposed to provide said one or more QOS parameters to said QOS management module.

2. The system of claim 1 wherein said QOS parameters include video parameters.

3. The system of claim 1 wherein said QOS parameters include audio parameters.

4. The system of claim 1 wherein said QOS parameters include VOIP parameters.

5. A system for managing quality of service (QOS) in a wireless network, said system comprising:
an agent disposed to manage operation of a wireless device included within said wireless network; and
a QOS management module disposed to provide control information to said agent, said control information being generated in accordance with QOS parameters and operational conditions of said wireless network.

6. The system of claim 5 further comprising an application semantics module disposed to provide application semantics information to said QOS management module.

7. The system of claim 5 wherein said QOS management module comprises a first submodule containing QOS rules and policies information and a second submodule containing known QOS patterns and conditions characteristic of said wireless network.

8. The system of claim 5 wherein said QOS parameters comprise RF channel information and RF channel prediction information, said control information generated by said QOS management module being at least in part based upon said RF channel information and said RF channel prediction information.

9. A method of managing quality of service (QOS) in a wireless network, the method comprising:
receiving, at a server, QOS criteria;
receiving, at said server, a network operating parameter;
determining a network operating configuration in accordance with said QOS criteria and said network operational parameter; and
sending, from said server, information relating to said network operating configuration to a plurality of wireless devices of said wireless network.
